(19) United States
(12) Patent Application Publication
(10) Pub. No.: US 2026/0023983 A1
(43) Pub. Date: Jan. 22, 2026

(54) DOMAIN GENERALIZATION AND ADAPTATION

(71) Applicant: QUALCOMM Incorporated, San Diego, CA (US)

(72) Inventors: Jamie Menjay LIN, San Diego, CA (US); Jisoo JEONG, San Diego, CA (US); Fatih Murat PORIKLI, San Diego, CA (US)

(21) Appl. No.: 18/775,878

(22) Filed: Jul. 17, 2024

(51) Int. Cl. G06N 3/0985; G06N 3/045; G06N 3/084

(52) U.S. Cl. CPC G06N 3/0985; G06N 3/045; G06N 3/084

(57) ABSTRACT

Certain aspects of the present disclosure provide techniques for performing domain generalization, including: inputting first input data into a first machine learning model; outputting, by the first machine learning model, a first value for a hyperparameter of a second machine learning model; inputting the first input data and the first value for the hyperparameter into the second machine learning model; and outputting, by the second machine learning model, a first result based on the first input data and the first value for the hyperparameter.

### INTRODUCTION

### Field of the Disclosure

Aspects of the present disclosure relate to machine learning models, and more particularly, to techniques for training machine learning models.

### Description of Related Art

Machine learning has emerged as a powerful tool for solving complex problems across various domains, including computer vision, natural language processing, and robotics. Machine learning models can be used for tasks such as image classification, object detection, and language translation, often surpassing human-level performance. Machine learning models, such as deep neural networks, can be trained on datasets involving one or more domains to learn patterns and relationships that enable them to make predictions or decisions on new, unseen data. A domain, in this context, may refer to a set of characteristics or features that define a particular area or scope of data. For example, in image classification, a domain could be defined by the type of images (e.g., medical images, natural landscapes, or facial images), the resolution of the images, or the lighting conditions under which the images were captured. When a machine learning model is trained on a dataset from one domain, the machine learning model learns to recognize patterns and relationships that may be specific to that domain. However, when a machine learning model is trained substantially on one domain, such training can sometimes limit the machine learning model's ability to generalize well to datasets from different domains. That is, if the machine learning model is provided with input data from a domain that differs from the domain it was trained on, its performance may degrade, leading to less accurate predictions or decisions.

In certain aspects, a significant challenge in the application of machine learning models is their ability to generalize to new or unseen domains. Domain shift, which refers to the differences in data characteristics between the training domain and the target domain, can degrade the performance of machine learning models. For example, a model trained on images captured under certain lighting conditions or from a particular viewpoint may fail to accurately classify objects when applied to images captured under different lighting conditions or from a different viewpoint. Similarly, a model trained on data from one geographic region may struggle to make accurate predictions when applied to data from another region with different demographic or environmental factors.

Various approaches have been proposed to address the problem of domain shift and improve the generalization capabilities of machine learning models. One common approach is to collect and annotate large, diverse datasets that cover a wide range of domains and variations. However, this can be time-consuming and may not always be feasible, especially for rare or hard-to-access domains. Another approach is to use transfer learning, where a model pre-trained on a large, general dataset is fine-tuned on a smaller dataset from the target domain. While transfer learning can improve performance on the target domain, it may still struggle to fully adapt to the specific characteristics of the new domain.

Domain adaptation techniques have also been explored to bridge the gap between the training domain and the target domain. These techniques aim to align the feature distributions of the source and target domains, either by learning domain-invariant representations or by transforming the source data to match the target domain. Some popular domain adaptation methods include adversarial training, where a discriminator network is used to encourage the model to learn domain-invariant features, and style transfer, where the style of the source data is modified to match the style of the target data. However, these methods often require access to data from the target domain during training, which may not always be available.

Despite the progress made in domain generalization and adaptation, there remains a need for more effective and efficient techniques that can enable machine learning models to perform well on new, unseen domains without requiring extensive data collection or manual adaptation. Such techniques could enhance the practical utility and reliability of machine learning models in real-world applications, where the data characteristics may vary significantly from the training data.

### SUMMARY

One aspect provides a method for performing domain generalization and/or domain adaptation. The method may include inputting the first input data into a first machine learning model; outputting, by the first machine learning model, a first value for a hyperparameter of a second machine learning model; inputting the first input data and the first value for the hyperparameter into the second machine learning model; and outputting, by the second machine learning model, a first result based on the first input data and the first value for the hyperparameter.

Other aspects provide: an apparatus operable, configured, or otherwise adapted to perform any one or more of the aforementioned methods and/or those described elsewhere herein; a non-transitory, computer-readable media comprising instructions that, when executed by a processor of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts a system for generalizing data domains for a machine learning model in accordance with aspects of the present disclosure.

FIG. 2 depicts an architecture for training a machine learning model in accordance with aspects of the present disclosure.

FIG. 3 depicts an architecture for training a machine learning model for generalizing and/or adapting data domains in accordance with aspects of the present disclosure.

FIG. 4 depicts a system for generalizing data domains for a machine learning model with input data from a first domain in accordance with aspects of the present disclosure.

FIG. 5 depicts a system for generalizing data domains for a machine learning model with input data from a second domain.

FIG. 6 illustrates an example artificial intelligence (AI) architecture that may be used for AI-enhanced wireless communications.

FIG. 7 illustrates an example AI architecture of a first wireless device that is in communication with a second wireless device.

FIG. 8 illustrates an example artificial neural network.

FIG. 9 depicts an example method for generalizing data domains for a machine learning model in accordance with aspects of the present disclosure.

FIG. 10 depicts aspects of an example processing system in accordance with aspects of the present disclosure.

### DETAILED DESCRIPTION

Aspects of the present disclosure provide apparatuses, methods, processing systems, and computer-readable mediums for domain generalization and adaptation in machine learning models.

Machine learning models are increasingly being used for various estimation tasks, such as depth estimation, optical flow computation, and semantic segmentation, in a wide range of applications including augmented reality, autonomous driving, and robotics. However, these models often struggle to generalize to new domains that are different from the ones they were trained on, leading to poor performance and limited practical usability. The present disclosure describes techniques for improving the domain generalization and/or adaptation capabilities of machine learning models, particularly in the context of estimation tasks.

A technical problem addressed by the techniques described herein is the lack of robustness and generalization of machine learning models when applied to data from new or unseen domains. For example, a depth estimation model trained on indoor scenes may fail to accurately predict depths when applied to outdoor scenes, due to differences in lighting conditions, object appearances, and scene geometry. Similarly, a semantic segmentation model trained on daytime images may struggle to correctly classify objects in nighttime images, due to variations in illumination and contrast. This problem of domain shift can limit the practical utility and reliability of machine learning models in real-world settings where the data characteristics may vary from the training data.

To address this problem, certain aspects provide a technical solution in the form of a domain-adaptive machine learning model architecture and/or training process. In some aspects, techniques described herein involve training a first machine learning model to predict domain-specific hyperparameters for a second machine learning model based on the characteristics of the input data. In some aspects, predicted hyperparameters predicted by the first machine learning model can be used to adapt the second machine learning model to the specific domain of the input data during inference. In some aspects, this allows the second model to dynamically adjust its behavior and representations to better match the characteristics of the input domain, leading to improved generalization and performance on unseen domains.

Hyperparameters can be understood as one or more settings that can control the behavior and performance of a machine learning model during training and inference. In some aspects, hyperparameters are generally set manually or determined through a search process, such as grid search or random search, and remain fixed throughout the training and inference phases. Examples of common hyperparameters include learning rate, batch size, number of hidden layers, and regularization strength.

However, certain aspects provide techniques to vary one or more hyperparameter values depending on characteristics associated with input data and/or characteristics of a domain associated with the input data. In some aspects, domain-specific hyperparameters may refer to hyperparameters that are dynamically selected or predicted based on characteristics of input data during inference, rather than being fixed and static.

Certain aspects provide techniques for training a first machine learning model to predict domain-specific hyperparameters for a second machine learning model. In some aspects, the first machine learning model learns to map characteristics associated with input data to hyperparameter values that improve (e.g., optimizes) the performance of the second model.

For example, during inference, the first machine learning model may receive the input data and predict domain-specific hyperparameters based on a learned mapping. The predicted domain-specific hyperparameters can then be used to adapt, or modify, the second machine learning model based on characteristics of the input data and, in some aspects, specific to a domain of the input data. In certain aspects, by dynamically adjusting the domain-specific hyperparameters, the second machine learning model can better match the characteristics associated with the input data, leading to improved generalization and performance on unseen domains.

Such an approach differs from traditional hyperparameter setting in several ways. For example, rather than using fixed, static hyperparameters during inference, certain aspects provide techniques that allow for dynamic selection of hyperparameters based on characteristics associated with the input data. As another example, certain aspects provide techniques for tailoring hyperparameters to the specific characteristics associated with the input data and/or the characteristics associated with the domain. As another example, certain aspects provide techniques for training the first machine learning model to learn a mapping between input data characteristics and hyperparameter values, which can reduce and/or eliminate the need for manual tuning or employing an extensive search processes for one or more hyperparameters.

Certain aspects provide techniques for allowing the hyperparameters to be selected dynamically during inference based on characteristics of a domain and/or characteristics of input data, thereby enabling a second machine learning model to be more flexible and adaptable to various domains. In some aspects, such a non-domain-specific approach can improve the model's ability to generalize and perform well on unseen domains, as the hyperparameters are based on characteristics of the input data and may be selected and/or generated by the trained first machine learning model.

In certain aspects, the selection of hyperparameter values impacts the performance and generalization ability of machine learning models across different domains. As previously discussed, in some aspects, hyperparameters can control various aspects of the machine learning model's behavior, such as its capacity, regularization strength, and learning dynamics. Thus, the hyperparameter values that provide more accurate and/or more precise outputs can vary depending on characteristics of the input data.

For example, consider a machine learning model trained primarily on indoor images; the machine learning model's hyperparameters, such as the learning rate, batch size, and number of hidden layers, may be tuned to capture specific features and patterns present in indoor scenes. However, when the same machine learning model is applied to a different domain, such as outdoor images, the previously utilized hyperparameter values may not be suitable. Outdoor images may have different lighting conditions, object scales, and scene layouts compared to indoor images. Accordingly, the machine learning model's hyperparameters may need to be adjusted in order to achieve a desired level of performance.

Accordingly, certain aspects provide techniques for generating domain-specific hyperparameter values by training a separate machine learning model to predict the hyperparameter values based on the characteristics of the input data. Thus, in certain aspects, a primary model trained to perform a task can adapt its behavior and representations to better match characteristics associated with the characteristics associated with the input data during inference. That is, the machine learning model learns to map the input data characteristics to the corresponding hyperparameter values that improve the performance of the primary model.

In certain aspects, techniques discuss herein may offer various benefits and advantages over existing approaches. For example, by automatically predicting domain-specific hyperparameters, certain techniques discussed herein may reduce the need for manual tuning or specification of hyperparameters for each new domain, which can be time-consuming and require significant expertise. In certain aspects, by adapting the model to the specific characteristics associated with input data, certain techniques discussed herein may enable improved generalization and robustness to domain shifts, leading to more accurate and reliable estimates in real-world settings. In certain aspects, by encapsulating the domain adaptation process within the model architecture itself, certain techniques discussed may provide a more efficient way to handle domain variations without requiring separate pre-processing or post-processing steps. In certain aspects, certain techniques discussed herein may be applied to a wide range of estimation tasks and model architectures, making such techniques versatile for improving the practical utility of machine learning models.

### Example Operations for Domain Generalization and Adaptation in Machine Learning Models

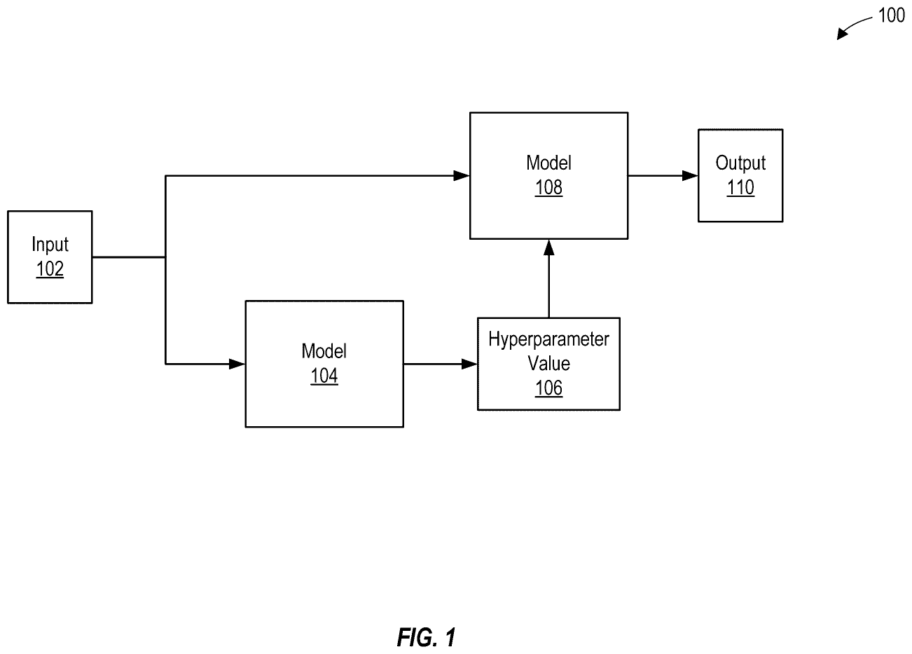

FIG. 1 depicts a system 100 for generalizing data domains for a machine learning model in accordance with aspects of the present disclosure. In certain aspects, the system 100 may include input data 102 that is provided to a machine learning model 104. In some aspects, the machine learning model 104 may generate a hyperparameter value 106 based on the input data 102. The hyperparameter value 106 and the input data 102 can then be provided as inputs to a machine learning model 108. The machine learning model 108 can generate an output 110 based on the input data 102 and the hyperparameter value 106.

In some examples, the input data 102 may include data from one or more domains. In certain aspects, a domain can refer to a specific area or category of data that shares similar characteristics or properties. For instance, in the context of image classification, different domains could include indoor images, outdoor images, daytime images, nighttime images, or images from specific geographic locations. In the context of natural language processing, different domains could include news articles, social media posts, scientific papers, or legal documents. Each domain may have its own unique features, styles, or challenges that a machine learning model needs to adapt to.

In some aspects, the input data 102 may be provided in one or more formats, including, but not limited to, image, video, audio, text, structured data, unstructured data, or any combination thereof. In some aspects, the input data 102 may be pre-processed before being provided as an input to the machine learning model 104. The pre-processing may include normalization, feature extraction, dimensionality reduction, or other techniques to prepare the input data 102 for use with the machine learning models. In some aspects, one or more sensors may be configured to capture and provide the input data 102. For example, one or more image sensors (e.g., one or more cameras) may be configured to capture one or more images, and may provide the one or more images as input data 102.

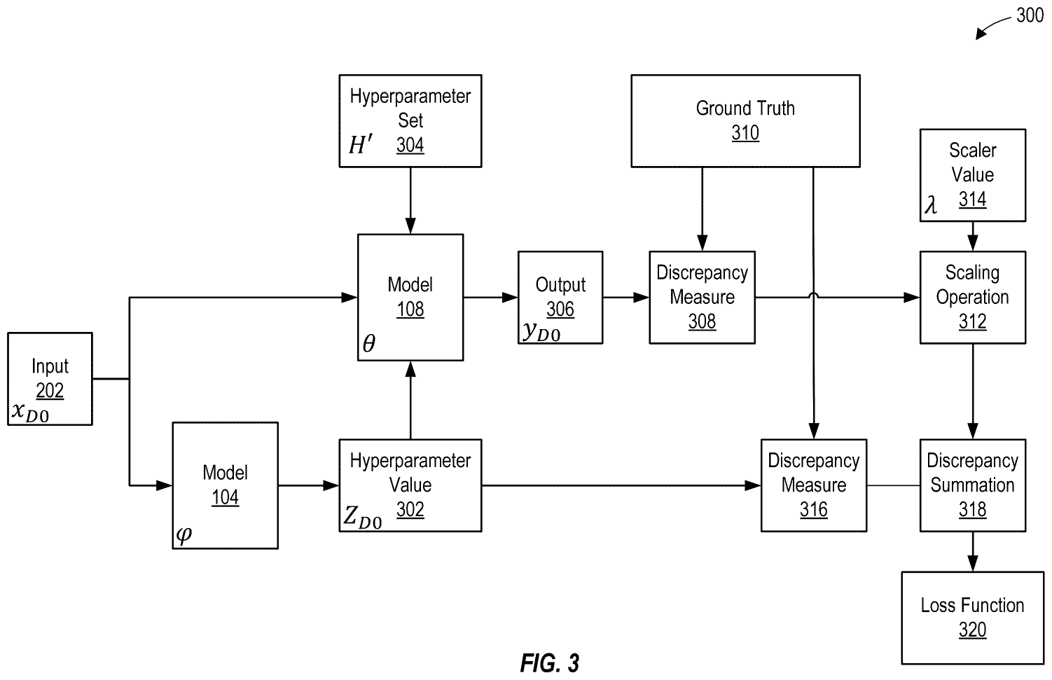

In some aspects, the machine learning model 104 may be configured to generate the hyperparameter value 106 based on the input data 102. In some examples, the machine learning model 104 may be a neural network, such as, but not limited to, a convolutional neural network (CNN), recurrent neural network (RNN), or other type of neural network. The machine learning model 104 may also use one or more other machine learning techniques, such as, but not limited to, decision trees, support vector machines, Bayesian networks, or ensemble methods. In some examples, the machine learning model 104 may be trained primarily on a single data domain (e.g., indoor images). In some examples, the machine learning model 104 may be trained secondarily on another different data domain (e.g., outdoor images), where the number of training examples of the second data domain is substantially less than the number of training examples of the primary domain. In some examples, the machine learning model 104 can be trained on a diverse set of data domains to learn to generate appropriate hyperparameter values for different input data characteristics. Training of a machine learning model is discussed in more detail herein with respect to FIG. 3. In some aspects, the hyperparameter value 106 generated by the machine learning model 104 can be used to configure the machine learning model 108 for input data 102. In examples, hyperparameters may refer to variables that govern the training process and model architecture of machine learning models. Examples of hyperparameters include, but are not limited to, learning rate, number of hidden layers, number of units per layer, activation functions, regularization parameters, and others.

In machine learning, there is a difference between hyperparameters and learnable parameters of a model. Learnable parameters, also known as model parameters or trainable parameters, generally refers to variables that a machine learning model learns during a training process. These parameters may be updated iteratively based on training data and an algorithm to minimize the machine learning model's loss function. Examples of learnable parameters include, but are not limited to, the weights and biases of a neural network. As previously discussed, hyperparameters generally refer to variables that govern a training process and/or model architecture but are not learned directly from the training data. In certain aspects, hyperparameters are typically set before a training process begins and remain fixed throughout the training. Such hyperparameters can define, at a high-level, the structure and behavior of the model, such as the learning rate, number of hidden layers, activation functions, and regularization strength. Traditionally, hyperparameters are not learned by the machine learning model itself during training. Instead, they are often determined through manual tuning, grid search, or random search, where different combinations of hyperparameter values are evaluated to find the best-performing configuration. This process is separate from the model's learning of its trainable parameters.

In certain aspects, techniques herein may involve learning hyperparameters using a separate machine learning model (e.g., the machine learning model 104). That is, instead of treating all hyperparameters as fixed and static, one or more hyperparameters can be dynamically predicted based on characteristics of the input data. In certain aspects, the machine learning model 104 can be trained to learn the mapping between input data characteristics and hyperparameter values for a primary model (e.g., the machine learning model 108). In certain aspects, during training, the machine learning model 104 receives input data primarily associated with one domain and learns to predict the hyperparameter values that improve the performance of the primary model.

In certain aspects, this training process may be distinguishable from the traditional learning of trainable parameters in several ways. In certain aspects, one or more hyperparameters can be learned by a separate model (machine learning model 104) rather than being configured and integrated into the primary model (machine learning model 108) as part of its trainable parameters. In certain aspects, the primary model (machine learning model 108) does not learn one or more hyperparameters directly from the training data. Instead, it receives the hyperparameter values predicted by the separate model (machine learning model 104) based on the input data characteristics. In certain aspects one or more predicted hyperparameters can be tailored to a specific domain associated with the input data, allowing the primary model to adapt its behavior and representations accordingly during inference. Thus, by training a separate model to learn the mapping between input data characteristics and hyperparameter values (e.g., optimal hyperparameter values), the primary model can dynamically adapt to different domain associated with the input data. In certain aspects, the techniques herein may allow the hyperparameters to be adjusted based on the specific characteristics associated with the input data, leading to improved performance and generalization on unseen domains.

In certain aspects, the hyperparameter value 106 may represent a range of values for a specific hyperparameter. For example, the hyperparameter value 106 could represent a range of learning rates (e.g., 0.001 to 0.01) or a range of regularization strengths (e.g., 0.1 to 1.0) that the machine learning model 108 can adapt based on the input data 102.

In some examples, a learned hyperparameter may be distinguished from a non-learned hyperparameter according to the following: non-learned hyperparameters can be typically set manually by a user or determined through a search process, such as grid search or random search. These non-learned hyperparameters may remained fixed during a training and inference phases of the model. In contrast, learned hyperparameters, such as the hyperparameter value 106 in the present disclosure, can be generated by a separate model (e.g., the machine learning model 104) and can adapt dynamically based on characteristics of the input data. Thus, a learned hyperparameter can allow for more flexibility and adaptability in handling different data domains.

In certain aspects, the machine learning model 108 can take both the input data 102 and the hyperparameter value 106 generated by the machine learning model 104 as inputs. In some examples, the machine learning model 108 may have a similar or different architecture than the machine learning model 104. The machine learning model 108 can be trained to perform a task, such, as but not limited to, classification, regression, semantic segmentation, object detection, image generation, or others. In certain aspects, the incorporation of the hyperparameter value 106 allows the machine learning model 108 to adapt to different data domains dynamically.

For example, by taking the hyperparameter value 106 as an input, the machine learning model 108 can adjust its internal representations and outputs based on the characteristics of the input data 102. This can allow the system 100 to generalize to new, unseen data domains without requiring extensive fine-tuning or retraining of the machine learning model 108. In certain aspects, generalization may refer to the ability of a machine learning model to perform well on data that it has not seen during training. In the context of the present disclosure, to “perform well” can mean that the machine learning model can accurately and effectively complete its intended task, such as classification, prediction, or regression, on data from domains that it was not explicitly trained on. For example, if a machine learning model was trained to classify images of cats and dogs using a dataset of pet photos, to perform well could mean that the machine learning model can accurately identify cats and dogs in images from different domains, such as wildlife photos or drawings, without a significant drop in accuracy compared to its performance on the original training data. In the context of the present disclosure, generalization can be achieved by the system 100 adapting to different data domains through the use of the learned hyperparameter value 106. This dynamic adaptation enables the machine learning model 108 to handle a wider range of input data characteristics and maintain good performance across various domains.

In some aspects, the hyperparameter value 106 acts as a domain-specific modulator that can alter or change the behavior of the machine learning model 108 to better handle unique properties or characteristics associated with a domain. For example, if the input data 102 belongs to a domain with high noise levels, the hyperparameter value 106 may adjust the regularization strength or the number of layers used during an inference operation in the machine learning model 108 to prevent overfitting. Similarly, if the input data 102 belongs to a domain with limited training samples, the hyperparameter value 106 may adjust the learning rate or the batch size during the training process.

In certain aspects, the techniques herein may be directed to stereo depth estimation; accordingly, the input data 102 may include stereo image pairs having characteristics of different domains, such as indoor scenes, outdoor scenes, or scenes with varying lighting conditions. For example, the machine learning model 108 can be a deep neural network trained to estimate depth maps from the stereo image pairs. In some aspects, at least one of the hyperparameters relevant to stereo depth estimation may include a maximum disparity range. In examples, the maximum disparity range can indicate a range of possible pixel disparities between left and right images in a stereo pair. In some aspects, maximum disparity range can be used to determine a maximum depth that can be estimated by the machine learning model 108. Thus, if the input data 102 has characteristics associated with a domain having large depth variations, such as outdoor scenes with distant objects, the hyperparameter value 106 may adjust the maximum disparity range to a higher value, allowing the machine learning model 108 to estimate depths more accurately for a wider range of distances.

Conversely, if the input data 102 has characteristics associated with a domain having smaller depth variations, such as indoor scenes with close-range objects, the hyperparameter value 106 may adjust the maximum disparity range to a lower value, allowing the machine learning model 108 to estimate depths more accurately for a narrow range of distances while reducing computational complexity. Accordingly, certain aspects provide techniques for dynamically adjusting the maximum disparity range based on the characteristics of the input domain such that the machine learning model 108 can adapt its behavior and modify its performance for different scenarios in stereo depth estimation. In some aspects, other hyperparameters that can be adjusted for stereo depth estimation include, but are not limited to, a number of disparity levels, and a regularization strength for smoothness constraints.

In certain aspects, the output 110 generated by the machine learning model 108 can be a final result of the system 100. Depending on the task, the output 110 may be one or more of a classification label, a regression value, a segmentation mask, bounding boxes around detected objects, a generated image, or any other type of output appropriate for the application. In some examples, the output 110 may be post-processed to extract insights or make decisions based on the model predictions.

### Example Machine Learning Model Training Framework

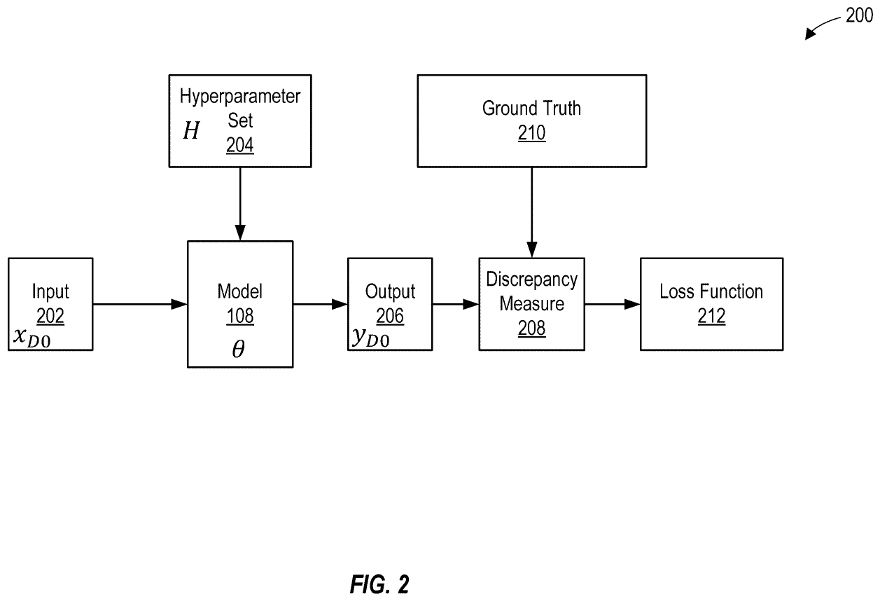

FIG. 2 depicts a general framework 200 for training a machine learning model using a given hyperparameter set 204 in accordance with aspects of the present disclosure. In certain aspects, the generalized framework 200 can include an input 202 that is provided to the machine learning model 108. In certain aspects, the machine learning model 108 generates an output 206 based on the input 202 and a hyperparameter set 204. The generalized framework 200 can also include a discrepancy measure 208 that compares the output 206 with a ground truth 210 to calculate a loss function 212. In some aspects, the loss function 212 may be used to update the machine learning model 108 during the training process.

In some examples, the input 202 may include data from one or more domains, similar to the input data 102 described in FIG. 1. The input 202 can be in various formats, such as one or more of image, video, audio, text, structured data, unstructured data, or any combination thereof. In some aspects, the input 202 may under undergo one or more pre-processing steps before being fed into the machine learning model 108. These pre-processing steps may include one or more of normalization, feature extraction, data augmentation, or other techniques to prepare the input 202 for training the machine learning model 108.

In some aspects, the machine learning model 108 can be any type of machine learning model, such as, but not limited to, a neural network, decision tree, support vector machine, ensemble model, etc. in certain aspects, the machine learning model 108 takes the input 202 and generates the output 206 based on its current set of parameters and the hyperparameter set 204. The architecture and complexity of the machine learning model 108 may vary depending on the specific task and the characteristics of the input data.

In certain aspects, the hyperparameter set 204 includes one or more hyperparameters that control the behavior and training dynamics of the machine learning model 108. In some aspect, the hyperparameter set 204 may refer to hyperparameters that are not learned from the training data but are set before the training process begins. Examples of hyperparameters in the hyperparameter set 204 may include, but are not limited to, learning rate, batch size, number of epochs, regularization strength, dropout rate, or architecture-specific parameters such as the number of layers or hidden units. In some aspects, the hyperparameter set 204 is fixed throughout the training process, while in other aspects, it may be adjusted dynamically based on the performance of the machine learning model 108. In the conventional training process of the machine learning model 108, the hyperparameter set 204 is fixed throughout a training process. Thus, the machine learning model 108 learns its parameters based on the fixed hyperparameters and the training data.

In certain aspects, the output 206 generated by the machine learning model 108 can be compared with the ground truth 210 using a discrepancy measure 208. In some aspects, the ground truth 210 may represent a desired or expected output for the corresponding input 202. The ground truth 210 can serve as a reference for evaluating the performance of the machine learning model 108 during training. In certain aspects, the discrepancy measure 208 can quantify the difference between the output 206 and the ground truth 210. Common discrepancy measures include, but are not limited to, mean squared error, cross-entropy loss, or domain-specific metrics such as intersection over union (IoU) for object detection tasks.

In certain aspects, the discrepancy measure 208 can be used to calculate a loss, or otherwise be evaluated using a loss function 212, which provides a quantitative measure of how well the machine learning model 108 is performing on the training data. In some examples, the loss function 212 can aggregate the discrepancies between the outputs and the ground truths across a batch or an entire dataset, with a goal of the training process being to minimize a loss as evaluated by the loss function 212, which in turn improves the model's performance and generalization ability. In some aspects, the choice of the loss function 212 can depend on a specific task and the desired optimization objective.

In certain aspects, and during the training process, the learnable parameters of the machine learning model 108 may be iteratively updated based on the gradients of the loss function 212, while in some aspects, hyperparameters in the hyperparameter set 204 remain fixed during the training process. In examples, such updating can be performed using one or more optimization algorithms such as, but not limited to, stochastic gradient descent (SGD), Adam, or AdaGrad. For example, the gradients can be calculated through backpropagation, which propagates an error signal from the loss function 212 back through the machine learning model 108. The model's learnable parameters can then be adjusted in a direction that minimizes the loss as evaluated by the loss function 212. This process can be repeated for multiple iterations or epochs until a satisfactory level of performance is achieved or a predefined stopping criterion is met.

In some examples, the training process depicted in FIG. 2 can be extended or modified based on the specific requirements of the task and the available data. For example, techniques such as cross-validation, early stopping, or learning rate scheduling can be incorporated to improve the generalization performance of the machine learning model 108 and prevent or reduce overfitting. Additionally, the hyperparameter set 204 can be optimized using techniques like grid search, random search, or Bayesian optimization to find the best combination of hyperparameters for the machine learning model 108.

In the context of optimizing the hyperparameter set 204 using techniques like grid search, random search, or Bayesian optimization, the term “best” can refer to the combination of hyperparameters that yields the most favorable performance of the machine learning model 108 on a given task. In some aspects, a best hyperparameter combination is typically determined by evaluating the model's performance on a validation dataset or through cross-validation, where the model's performance is assessed on data that was not used during the training process. This allows for an unbiased estimate of the model's generalization ability. The best hyperparameter combination is the one that maximizes a chosen performance metric, such as accuracy, precision, recall, F1 score, or any other metric relevant to the specific task at hand. By selecting the best hyperparameter combination, the machine learning model 108 is more likely to achieve optimal performance and generalize well to new, unseen data.

As previously described, by comparing the output 206 of the machine learning model 108 with the ground truth 210 using the discrepancy measure 208 and optimizing the loss function 212, the machine learning model 108 can learn to generate accurate predictions or outputs for the input 202. The trained machine learning model 108 can then be used for inference on new, unseen data, belonging to a data domain on which it was trained as described in FIG. 2. However, inference on data belonging to a different data domain may fail or otherwise may not generate accurate and/or robust results. For example, a training algorithm f for learnable model weights θ typically involves a pre-defined set of non-learnable hyperparameters H for a chosen data domain D₀ of input x_{D0} in that data domain, where during training, θ_{D0}=argmin_{θ}f (x_{D0}, H, GTₓ) and during inference y_{D0}=M_{θ}_{_{D0}}(\acute{x}_{D0}, H), where argmin_{θ} represents the optimization notation indicating the process of finding the optimal values of the model parameters θ that minimize an objective function or loss function, in this case, denoted by f(x_{D0}, H, GTₓ); GTₓ represents the ground truth or target values that the model is trying to predict or estimate; and M_{θ}_{_{D0}} represents the machine learning model M with parameters θ, trained on a specific data domain D₀. In examples, even though \acute{x}_{D0}≠x_{D0}, because both \acute{x}_{D0} and x_{D0} belong to the same data domain D₀, an inference operation still works well. However, a sample x_{D1} that belongs to another data domain D₁ may fail (e.g., y_{D1}=M_{θ}_{_{D0}}(x_{D1}, H) does not yield a good result, as the domains for model training and model inference may be different D₁≠D₀ for x_{D1} and M_{θ}_{_{D0}}).

Example Machine Learning Model Training Framework for Generalizing and/or Adapting to Data Domains

FIG. 3 depicts an architecture 300 for training a machine learning model (e.g., machine learning model 108) for generalizing and/or adapting to data domains in accordance with aspects of the present disclosure. In certain aspects, the architecture 300 may extend the training process described in FIG. 2 by incorporating the machine learning model 104 that can generate a hyperparameter value 302 based on the input 202. In certain aspects, the hyperparameter value 302 can be used as an additional input to the machine learning model 108, along with the hyperparameter set 304, which may be a subset of the hyperparameter set 204 of FIG. 2. A subset may refer to a collection of elements that are part of a larger set, meaning that the hyperparameter set 304 may contain some, but not necessarily all, of the hyperparameters from the hyperparameter set 204. In some cases, the hyperparameter set 304 may be empty, indicating that all hyperparameter values provided to the machine learning model 108 may be output from machine learning model 104 based on the input data, without relying on any additional fixed hyperparameters.

As previously discussed, the input 202 in FIG. 3 can serve the same purpose as in FIG. 2, providing data from one or more domains to the machine learning model 104 and machine learning model 108. In certain aspects, the input 202 can be in various formats and may undergo one or more pre-processing steps to prepare it for a training process. In some aspects, the input 202 is selected from a diverse set of domains to enhance the generalization and adaptation capabilities of the trained models. In some examples, the input 202 may be primarily associated with a first domain, where another input provided to the machine learning model 104 and machine learning model 108 may be associated with a secondary domain.

As previously described, the machine learning model 104 may be a machine learning model that takes the input 202 and generates the hyperparameter value 302. The machine learning model 104 can be any type of machine learning model, such as but not limited to, a neural network, decision tree, or support vector machine. In some examples, the machine learning model 104 may be trained to learn the relationship between the input data characteristics and hyperparameter values for the machine learning model 108. The hyperparameter value 302 generated by the machine learning model 104 can take various forms, such as a single value, a range of values, or a set of values that represent certain statistical characteristics of the hyperparameters. That is, the machine learning model 104 (e.g., φ in FIG. 3) may take all or a subset of x_{D0} and generate one or more parameter range estimates, or latent feature Zₚ, dynamically based on a given input of x_{D0}. Thus, the latent feature Zₚ together with the input x_{D0} can be used to train a model M_{θ} (e.g., machine learning model 108), where during training the model parameters θ given φ=argmin_{θ,φ}\acute{f}(x_{D0}, H, GTₓ) and inference for y_{D0}=M_{θ,φ}(\acute{x}_{D0}, H) and y_{D1}=M_{θ,φ}(x_{D1}, \acute{H}), where \acute{f} represents a new training function that takes GTₓ to generate loss and gradients to minimize losses for both θ and φ. In examples, \acute{H} may represent a reduced set of hyperparameters that excludes one or more relevant/sensitive hyperparameters due in part to one or more data domain shifts. Thus, the trained model M_{θ,φ} can work well for both inputs \acute{x}_{D0} and x_{D1} belonging to data domains D₀ and D₁.

More specifically, and with respect to FIG. 3, Z_{D0} represents the hyperparameter value 302 (or latent feature specific to domain D₀) generated by the machine learning model 104, denoted as φ. The model 104 can take the input x_{D0} (input 202) and learn the parameters θ_{φ} to generate the hyperparameter value Z_{D0}. As provided above, y_{D0} may represent the output 306 generated by the machine learning model 108. That is, the machine learning model 108 takes x_{D0} (input 202) and the hyperparameter value Z_{D0} (hyperparameter value 302) generated by the machine learning model 104. In some examples, the hyperparameter set H′ (hyperparameter set 304) is not an input to the machine learning model 108 but rather a part of the trained model itself. That is, the hyperparameter set H′ represents the hyperparameters that are fixed and not generated by the machine learning model 104. These hyperparameters (e.g., set H′) may be incorporated into the architecture and training process of the machine learning model 108. The machine learning model 108 can generate the output y_{D0}.

The hyperparameter set \acute{H} may represent a subset of the hyperparameter set H from FIG. 2, containing those hyperparameters that are not generated by the machine learning model 104. The hyperparameter value Z_{D0}, generated by the machine learning model 104, represents a hyperparameter that was included in the hyperparameter set H (e.g., hyperparameter set 204 of FIG. 2) but not in the hyperparameter set \acute{H} (e.g., hyperparameter set 304).

By generating the hyperparameter value Z_{D0} based on the input data characteristics, the machine learning model 104 can enable the machine learning model 108 to adapt its behavior and improve its generalization and domain adaptation capabilities. The machine learning model 104 can learn to map the input data 202 to one or more appropriate hyperparameter values, allowing the machine learning model 108 to dynamically adjust its configuration based on the input data (e.g., input 202).

In some aspects, the output 306 generated by the machine learning model 108 can be compared with the ground truth data 310 using the discrepancy measure 308. The discrepancy measure 308 can quantify the difference or dissimilarity between the output 306 and the ground truth data 310. In some aspects, the discrepancy measure 308 can be a simple subtraction operation to calculate the difference between the output 306 and the ground truth data 310. For example, if the output 306 represents predicted values and the ground truth data 310 represents actual values, the discrepancy measure 308 can calculate the absolute difference or squared difference between the predicted and actual values.

In other aspects, the discrepancy measure 308 can be a more complex function or metric that captures specific characteristics of the task. For instance, in image segmentation tasks, the discrepancy measure 308 can be the Intersection over Union (IoU) metric, which calculates the overlap between the predicted segmentation mask and the ground truth mask. In object detection tasks, the discrepancy measure 308 can be the Average Precision (AP) metric, which evaluates the precision and recall of the detected objects compared to the ground truth annotations. Similarly, the hyperparameter value 302 generated by the machine learning model 104 can be compared with a corresponding value derived from the ground truth data 310 using a discrepancy measure 316. In certain aspects, the ground truth data 310 contains information or characteristics that are directly related to certain hyperparameters. By analyzing the ground truth data 310, it is possible to determine optimal or expected values for these hyperparameters. In some aspects, the purpose of this comparison is to ensure that the machine learning model 104 learns to generate hyperparameter values that are consistent with underlying characteristics of the ground truth data. The discrepancy measure 316 can be similar to the discrepancy measure 308, calculating the difference or dissimilarity between the generated hyperparameter value 302 and the corresponding ground truth-derived value.

In certain aspects, the hyperparameter value 302 generated by the machine learning model 104 can be compared directly with the ground truth data 310 using a discrepancy measure 316. For example, in a depth estimation task, the hyperparameter value 302 may represent the maximum depth range. The ground truth data 310 may contain the true depth values for each pixel in the input images. In some aspects, the discrepancy measure 316 can calculate the absolute difference or squared difference between the generated maximum depth range and the actual maximum depth value observed in the ground truth data 310. This direct comparison allows the machine learning model 104 to learn to generate hyperparameter values that are consistent with the characteristics of the ground truth data 310. In some aspects, the discrepancy measure 316 can be similar to the discrepancy measure 308, calculating the difference or dissimilarity between the generated hyperparameter value 302 and the corresponding ground truth data 310.

As another example, if the hyperparameter value 302 represents a range of values for a specific hyperparameter, such as the learning rate or regularization strength, the discrepancy measure 316 can calculate the absolute difference or squared difference between the generated range and the optimal range determined based on characteristics of the ground truth data 310. In certain aspects, the range (e.g., an optimal range) for a hyperparameter can be derived from the ground truth data by analyzing a distribution or statistical properties of the relevant ground truth values. For instance, in the case of depth estimation, the maximum disparity hyperparameter can be determined by examining the range and distribution of disparity values in the ground truth depth data. Alternatively, if the hyperparameter value 302 represents a categorical variable, such as the choice of activation function or optimizer, the discrepancy measure 316 can use a categorical cross-entropy loss to measure the dissimilarity between the generated choice and the ground truth choice.

In some aspects, the discrepancies calculated by the discrepancy measures 308 and 316 can be combined using a discrepancy summation 318, which may involve scaling operations (e.g., scaling operation 312 using a scaler value 314) or other mathematical operations to balance the contributions of the individual discrepancies. The combined discrepancies can then be evaluated with the loss function 320. In some aspects, the loss function 320 can provide a quantitative measure of the overall dissimilarity between the output of the machine learning model 104 and machine learning model 108 and the ground truth data 310. The choice of the loss function can depend on the specific task and the desired optimization objective. Some common examples of loss functions include, but are not limited to: (1) Mean Squared Error (MSE): MSE, commonly used in regression tasks, can calculate the average squared difference between the predicted values and the ground truth values; (2) Cross-Entropy Loss: Cross-entropy loss, often used in classification tasks, measures the dissimilarity between predicted probability distributions and ground truth distributions; (3) Kullback-Leibler (KL) Divergence: KL divergence can quantify a difference between two probability distributions, such as the dissimilarity between the generated hyperparameter values and the ground truth values; and (4) Weighted Combination of Losses, for example, the loss function 320 can be a weighted combination of multiple individual loss functions, each capturing different aspects of the task. That is, the loss function 320 can be a weighted sum of the MSE loss for the output 306 and the KL divergence loss for the hyperparameter value 302.

At least one goal of the training process described in FIG. 3 is to minimize the loss evaluated by the loss function 320, which in turn improves the generalization and domain adaptation capabilities of the machine learning model 104 and machine learning model 108. By minimizing the discrepancies between the output of the machine learning model 104 and machine learning model 108 and the ground truth, the architecture 300 depicted in FIG. 3 can learn to generate accurate and domain-adaptive predictions. That is, during the training process, the machine learning model 104 and machine learning model 108 can be iteratively updated based on the gradients of the loss function 320 with respect to their parameters. The gradients ca be calculated through backpropagation, and the model parameters can be adjusted using optimization algorithms such as stochastic gradient descent (SGD) or Adam. By incorporating the machine learning model 104 to generate hyperparameter values based on the input data characteristics, the architecture 300 can enable the machine learning model 108 to dynamically adjust its configuration and improve its performance across different data domains.

### Example Systems for Generalizing Data Domains for a Machine Learning Model

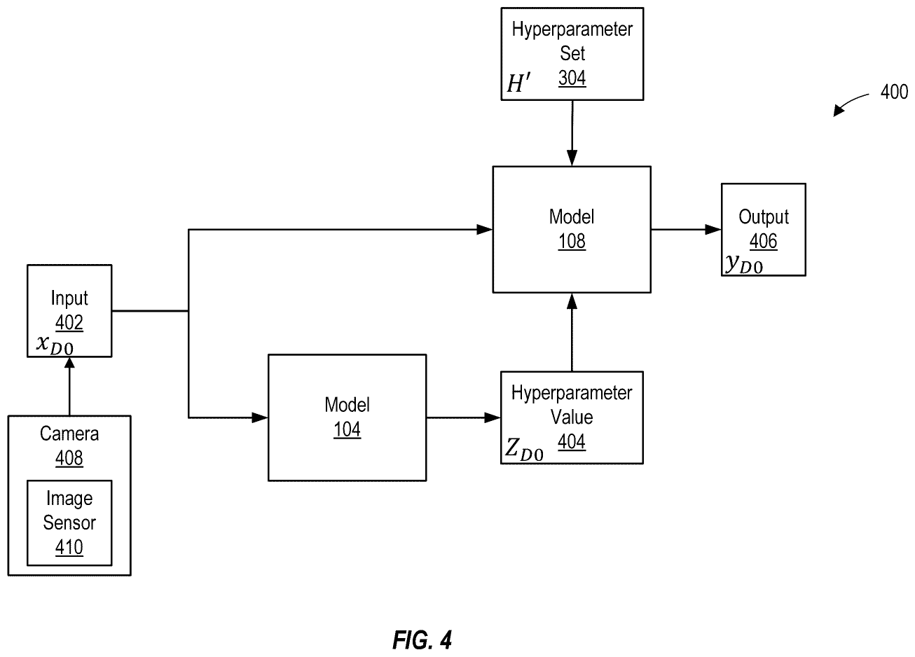

FIG. 4 depicts a system 400 for generalizing data domains for a machine learning model in accordance with aspects of the present disclosure. In some aspects, the system 400 may include an input data 402 from a first domain, which is provided to a machine learning model 104. The machine learning model 104 can generate a hyperparameter value 404 based on the input data 402. The hyperparameter value 404, along with the input data 402, can then be used as inputs to the machine learning model 108, which can generate an output 406. In some instances, the hyperparameter set 304 can be provided as an input to the machine learning model 108. In other instances, the hyperparameter set 304 may be integrated into the machine learning model 108 during the training process. That is, the values of the hyperparameters in the hyperparameter set 304 may be fixed or embedded within the learned parameters of the machine learning model 108, rather than being provided as a separate input.

In some examples, the input data 402 represents data from a first domain, which may be different from the domain(s) used during the training process described in FIG. 3. In some examples, the input data 402 represents data from a first domain, which may be the same domain used during the training process described in FIG. 3. In some aspects, the first domain can be any domain that the system 400 is intended to generalize to, even if it was not explicitly included in the training data. For example, in an image classification task, the training data may include images from various domains such as natural scenes, urban environments, and indoor settings. In some aspects, the first domain represented by the input data 402 could be a specific subset of these domains, such as images captured under low-light conditions or images with a particular visual style.

In some aspects, the input data 402 can take various forms depending on the specific task and the nature of the data. In some examples, the input data 402 can be raw sensor data, such as pixel values from a camera or audio samples from a microphone. For example, an image sensor 410 of camera 408 may provide pixel values as input data 402. In some aspects, the camera 408 may be configured to capture one or more images. In other examples, the input data 402 can be pre-processed data, such as feature vectors extracted from images or text embeddings derived from natural language processing techniques. The input data 402 may also include metadata or contextual information that provides additional insights into the characteristics of the first domain.

In certain aspects, the machine learning model 104 can take the input data 402 and generate one or more hyperparameter values 404, such as based on characteristics of the input data 402. In examples, the machine learning model 104 may have been trained, as described in FIG. 3, to learn the relationship between characteristics of input data 402 and (e.g., the optimal) hyperparameter values for the machine learning model 108. By generating the hyperparameter value 404 based on the input data 402, the machine learning model 104 can enable the machine learning model 108 to adapt its behavior and generalize to the new domain.

In certain aspects, the hyperparameter value 404 generated by the machine learning model 104 can take various forms, as discussed in the description of FIG. 3. In some aspects, the hyperparameter value 404 can be a single value or a range of values that represent a specific hyperparameter, such as the learning rate, regularization strength, or number of layers in the machine learning model 108. In other aspects, the hyperparameter value 404 can be a set of values that encode multiple hyperparameters or a combination of hyperparameters that are relevant for adapting the machine learning model 108, to the input data 402 associated with the first domain.

In some aspects, the machine learning model can take the input data 402, the hyperparameter value 404 as inputs and generate the output 406. In some aspects, the hyperparameter set 304 is a subset of a hyperparameter set, as described in FIG. 3, and may be fixed or embedded within the learned parameters of the machine learning model 108. In examples, the hyperparameter set 304 may include the hyperparameter(s) that are not learned by the machine learning model 104 and that remain fixed during the inference process.

In some aspects, the machine learning model 108 can use the hyperparameter value 404 to adapt its internal representations and/or computations to the characteristics of the input data 402. In some aspects, the hyperparameter value 404 can directly modify the architecture or behavior of the machine learning model 108, such as adjusting the depth or width of the neural network layers, changing the activation functions, or modulating the attention mechanisms. In other aspects, the hyperparameter value 404 can indirectly influence the machine learning model 108 by controlling the flow of information or the weighting of different components within the model.

In certain aspects, the output 406 generated by the machine learning model 108 can be the final result of the system 400 for the input data 402 from the first domain. The nature of the output 406 can depend on the specific task and the desired outcome. In some examples, the output 406 can be a classification label, indicating the predicted category or class of the input data 402. In other examples, the output 406 can be a continuous value, such as a regression prediction or a probability score. The output 406 may also take the form of a structured prediction, such as a segmentation mask or a set of bounding boxes for object detection tasks.

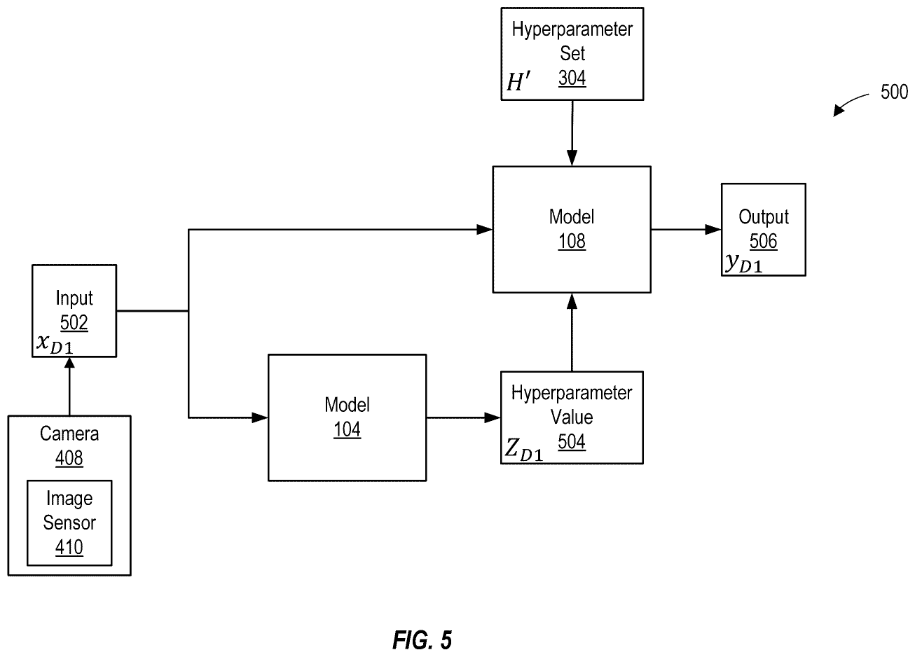

FIG. 5 depicts a system 500 for generalizing data domains for a machine learning model in accordance with aspects of the present disclosure. In some aspects, the system 500 may be similar to the system 400 described in FIG. 4, but may focus on the application of the trained models to input data from a second domain, which is different from the first domain discussed in FIG. 4. The system 500 can include an input data 502 from the second domain, which can be provided to a machine learning model 104. In some aspects, the image sensor 410 of camera 408 may provide pixel values as input data 502. In certain aspects, the machine learning model 104 can generate a hyperparameter value 504 based on the input data 502. In certain aspects, the hyperparameter value 504, along with the input data 502, can then be used as inputs to a machine learning model 108, which generates an output 506. In some instances, the hyperparameter set 304 can be provided as an input to the machine learning model 108. In other instances, the hyperparameter set 304 may be integrated into the machine learning model 108 during the training process. That is, the values of the hyperparameters in the hyperparameter set 304 may be fixed or embedded within the learned parameters of the machine learning model 108, rather than being provided as a separate input.

In some aspects, the input data 502 represents data from a second data domain, which is distinct from the first domain described in FIG. 4 and may also be different from the domains used during the training process described in FIG. 3. In some aspects, the second data domain can be any domain that the system 500 is intended to generalize to, emphasizing the adaptability and robustness of the trained machine learning models 104 and 108. In some aspects, the second data domain may have characteristics that are significantly different from the first data domain or the training domains, presenting new challenges for the models to handle.

For example, in a natural language processing task, the training data may include text from various domains such as news articles, scientific papers, and social media posts. The first data domain represented by the input data 402 in FIG. 4 could be a specific subset of these domains, such as legal documents. The second data domain represented by the input data 502 in FIG. 5 could be a completely different domain, such as customer reviews or technical manuals, which have distinct vocabulary, grammar, and writing styles compared to the training domains and the first data domain.

In some aspects, the input data 502 can take various forms depending on the specific task and the nature of the data, similar to the input data 402 described in FIG. 4. In some examples, the input data 502 can be raw data, such as images, audio recordings, or text documents. In other examples, the input data 502 can be pre-processed data, such as feature vectors, embeddings, or other representations that capture the relevant information from the raw data. The input data 502 may also include metadata or contextual information that provides additional insights into the characteristics of the second domain.

In some aspects, the machine learning model 104 can take the input data 502 and generate a hyperparameter value 504, such as based on the characteristics associated with the input data 502. In certain aspects, the model 104 has been trained to learn the relationship between the characteristics of the input data 502 and (e.g., the optimal) hyperparameter value(s) for the machine learning model 108, as described in FIG. 3. By generating the hyperparameter value 504, such as related to the second data domain, the machine learning model 104 can enable the machine learning model 108 to adapt its behavior and generalize to the new domain, even if it is different from the domains encountered during training.

In some aspects, the hyperparameter value 504 generated by the machine learning model 104 can take various forms, similar to the hyperparameter value 404 described in FIG. 4. In some aspects, the hyperparameter value 504 can be a single value or a range of values that represent a specific hyperparameter, such as the learning rate, regularization strength, or number of layers in the machine learning model 108. In other aspects, the hyperparameter value 504 can be a set of values that encode multiple hyperparameters or a combination of hyperparameters that are relevant for adapting the machine learning model 108 to the input data 502 associated with the second domain.

The machine learning model 108 can take the input data 502 and the hyperparameter value 504 as inputs and generate the output 506. In some aspects, the hyperparameter set 304 is a subset of the hyperparameter set used during the training process and may be fixed or embedded within the learned parameters of the machine learning model 108. The hyperparameter set 304 can include hyperparameter(s) that are not learned by the machine learning model 104 and that may remain fixed during an inference process.

In some aspects, the machine learning model 108 can receive the hyperparameter value 504 and adapt its internal representations and/or computations to the characteristics of the input data 502. In some aspects, the hyperparameter value 504 can directly modify the architecture or behavior of the machine learning model 108, such as adjusting the depth or width of the neural network layers, changing the activation functions, or modulating the attention mechanisms. In other aspects, the hyperparameter value 504 can indirectly influence the machine learning model 108 by controlling the flow of information or the weighting of different components within the model.

In some examples, the output 506 generated by the machine learning model 108 can represent the final result of the system 500 for the input data 502 from the second domain. The nature of the output 506 depends on the specific task and the desired outcome, similar to the output 406 described in FIG. 4. In some examples, the output 506 can be a classification label, indicating the predicted category or class of the input data 502. In other examples, the output 506 can be a continuous value, such as a regression prediction or a probability score. The output 506 may also take the form of a structured prediction, such as a segmentation mask or a set of bounding boxes for object detection tasks. In some aspects, by generating domain-specific hyperparameter values using the machine learning model 104, the system 500 enables the machine learning model 108 to produce more accurate and relevant outputs for the input data 502 from the second domain, even if it is significantly different from the domains encountered during training. This emphasizes the robustness and adaptability of the system 500 in handling diverse data domains without requiring extensive fine-tuning or retraining of the models.

### Example Artificial Intelligence System for Domain Generalization and Adaptation

Certain aspects described herein may be implemented, at least in part, using some form of artificial intelligence (AI), e.g., the process of using a machine learning (ML) model to infer or predict output data based on input data. An example ML model may include a mathematical representation of one or more relationships among various objects to provide an output representing one or more predictions or inferences. Once an ML model has been trained, the ML model may be deployed to process data that may be similar to, or associated with, all or part of the training data and provide an output representing one or more predictions or inferences based on the input data.

ML is often characterized in terms of types of learning that generate specific types of learned models that perform specific types of tasks. For example, different types of machine learning include supervised learning, unsupervised learning, semi-supervised learning, and reinforcement learning.

Supervised learning algorithms generally model relationships and dependencies between input features (e.g., a feature vector) and one or more target outputs. Supervised learning uses labeled training data, which are data including one or more inputs and a desired output. Supervised learning may be used to train models to perform tasks like classification, where the goal is to predict discrete values, or regression, where the goal is to predict continuous values. Some example supervised learning algorithms include nearest neighbor, naive Bayes, decision trees, linear regression, support vector machines (SVMs), and artificial neural networks (ANNs).

Unsupervised learning algorithms work on unlabeled input data and train models that take an input and transform it into an output to solve a practical problem. Examples of unsupervised learning tasks are clustering, where the output of the model may be a cluster identification, dimensionality reduction, where the output of the model is an output feature vector that has fewer features than the input feature vector, and outlier detection, where the output of the model is a value indicating how the input is different from a typical example in the dataset. An example unsupervised learning algorithm is k-Means.

Semi-supervised learning algorithms work on datasets containing both labeled and unlabeled examples, where often the quantity of unlabeled examples is much higher than the number of labeled examples. However, the goal of a semi-supervised learning is that of supervised learning. Often, a semi-supervised model includes a model trained to produce pseudo-labels for unlabeled data that is then combined with the labeled data to train a second classifier that leverages the higher quantity of overall training data to improve task performance.

Reinforcement Learning algorithms use observations gathered by an agent from an interaction with an environment to take actions that may maximize a reward or minimize a risk. Reinforcement learning is a continuous and iterative process in which the agent learns from its experiences with the environment until it explores, for example, a full range of possible states. An example type of reinforcement learning algorithm is an adversarial network. Reinforcement learning may be particularly beneficial when used to improve or attempt to optimize a behavior of a model deployed in a dynamically changing environment, such as a wireless communication network.

ML models may be deployed in one or more devices (e.g., network entities such as base station(s) and/or user equipment(s)) to support various wired and/or wireless communication aspects of a communication system. For example, an ML model may be trained to identify patterns and relationships in data corresponding to a network, a device, an air interface, or the like. An ML model may improve operations relating to one or more aspects, such as transceiver circuitry controls, frequency synchronization, timing synchronization, channel state estimation, channel equalization, channel state feedback, modulation, demodulation, device positioning, transceiver tuning, beamforming, signal coding/decoding, network routing, load balancing, and energy conservation (to name just a few) associated with communications devices, services, and/or networks. AI-enhanced transceiver circuitry controls may include, for example, filter tuning, transmit power controls, gain controls (including automatic gain controls), phase controls, power management, and the like.

Aspects described herein may describe the performance of certain tasks and the technical solution of various technical problems by application of a specific type of ML model, such as an ANN. It should be understood, however, that other type(s) of AI models may be used in addition to or instead of an ANN. An ML model may be an example of an AI model, and any suitable AI model may be used in addition to or instead of any of the ML models described herein. Hence, unless expressly recited, subject matter regarding an ML model is not necessarily intended to be limited to just an ANN solution or machine learning. Further, it should be understood that, unless otherwise specifically stated, terms such “AI model,” “ML model,” “AI/ML model,” “trained ML model,” and the like are intended to be interchangeable.

### Example Artificial Intelligence System for Domain Generalization and Adaptation

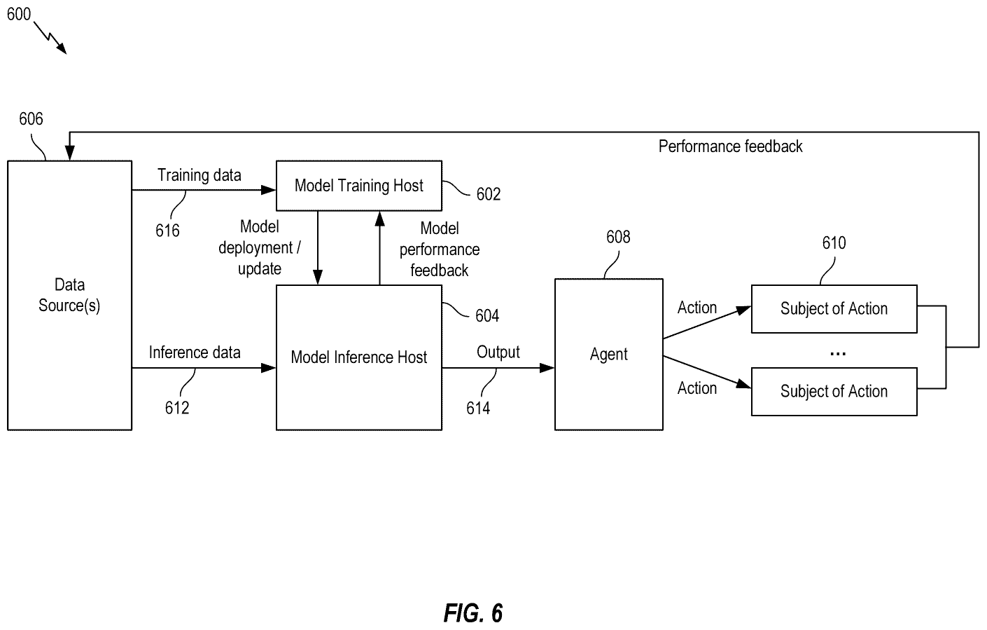

FIG. 6 is a diagram illustrating an example AI architecture 600 that may be used to implement the machine learning models and domain generalization and adaptation techniques described in this disclosure. As illustrated, the architecture 600 includes multiple logical entities, such as a model training host 602 for training the machine learning models with domain generalization, a model inference host 604 for running inference using the trained models with domain adaptation, data source(s) 606 providing training and inference data, and an agent 608 that utilizes the models' output. This AI architecture could be used to enable the example disclosed domain generalization and adaptation techniques in various machine learning applications.

The model inference host 604, in the architecture 600, is configured to run the trained machine learning models based on inference data 612 provided by data source(s) 606. The model inference host 604 may produce an output 614 (e.g., a prediction or inference, such as a discrete or continuous value) based on the inference data 612, that is then provided as input to the agent 608. The model inference host 604 utilizes the domain adaptation techniques described in this disclosure to generate hyperparameter values specific to the input data, enabling the models to adapt to new domains during inference.

The agent 608 may be an element or entity that utilizes the output of the machine learning models hosted by the model inference host 604. The agent 608 could be a software component, a hardware accelerator, or a system that leverages the domain-generalized estimates produced by the models for various downstream tasks such as image processing, depth estimation, or other regression and estimation problems.

For example, if the output 614 from the model inference host 604 is a depth estimate obtained through domain generalization, the agent 608 may be an augmented reality application that uses the depth information for rendering virtual objects. As another example, if the output 614 is an enhanced image produced by a model trained with domain generalization, the agent 608 could be an image editing software.

After receiving the output 614 from the model inference host 604, the agent 608 may determine how to utilize it. For instance, if the agent 608 is an augmented reality app and the output is a depth map, it may use the depth information to occlude virtual objects behind real ones or to place virtual objects on real surfaces in a plausible manner. If the agent 608 decides to use the output 614, it may apply it to the subject of the action 610, which represents the data being processed or enhanced. In the augmented reality example, the subject of action 610 would be the rendered scene. In some cases, the agent 608 and subject of action 610 may be tightly integrated.

The data sources 606 may be configured to collect data used as training data 616 for the model training host 602 to train the machine learning models employing domain generalization. The data sources 606 may also provide inference data 612 to the model inference host 604. This data could come from various entities and may include the subject of action 610. For example, for training a depth estimation model, the data sources 606 may collect stereo images and corresponding ground truth depth maps from multiple domains. The model training host 602 can then monitor the models' performance on this data to determine if retraining or fine-tuning with the domain generalization techniques is necessary to improve accuracy across domains. In some cases, the agent 608 and the subject of action 610 are the same entity.

The data sources 606 may be configured for collecting data that is used as training data 616 for training the machine learning models with domain generalization. The data sources 606 may also provide inference data 612 (also referred to as input data) for feeding the trained models during inference with domain adaptation. In particular, the data sources 606 may collect data relevant to the estimation task at hand from multiple domains, such as stereo images for depth estimation or video frames for optical flow computation. This data may come from various sources, including the subject of action 610, which represents the data being processed by the models. The collected data is provided to the model training host 602 for training and fine-tuning the models with domain generalization. For example, after the subject of action 610 (e.g., a stereo image pair) is processed by the models, the output 614 (e.g., a predicted depth map) may be compared to ground truth data to evaluate the models' performance across domains. If the output 614 is not sufficiently accurate or does not generalize well to new domains, this performance feedback may be used by the model training host 602 to further train the models using the disclosed domain generalization techniques, aiming to improve their estimation accuracy across diverse domains. The updated models may then be deployed to the model inference host 604.

In certain aspects, the model training host 602 may be deployed at or with the same or a different entity than that in which the model inference host 604 is deployed. For example, in order to offload model training processing, which can impact the performance of the model inference host 604, the model training host 602 may be deployed at a model server as further described herein. Further, in some cases, training and/or inference may be distributed amongst devices in a decentralized or federated fashion.

In some aspects, machine learning models utilizing domain generalization and/or adaptation techniques are deployed at or on a computing device for enhancing the performance of estimation tasks across diverse domains. More specifically, a model inference host, such as model inference host 604 in FIG. 6, may be deployed at or on the computing device for running the domain-adaptive and/or domain-generalized models to refine estimates and improve accuracy in new domains.

In some other aspects, the domain-generalized machine learning models are deployed at or on an embedded system or mobile device for enabling efficient on-device inference across domains. More specifically, a model inference host, such as model inference host 604 in FIG. 6, may be deployed at or on the embedded system or mobile device for running the models to obtain high-quality estimates while meeting resource constraints and adapting to different domains.

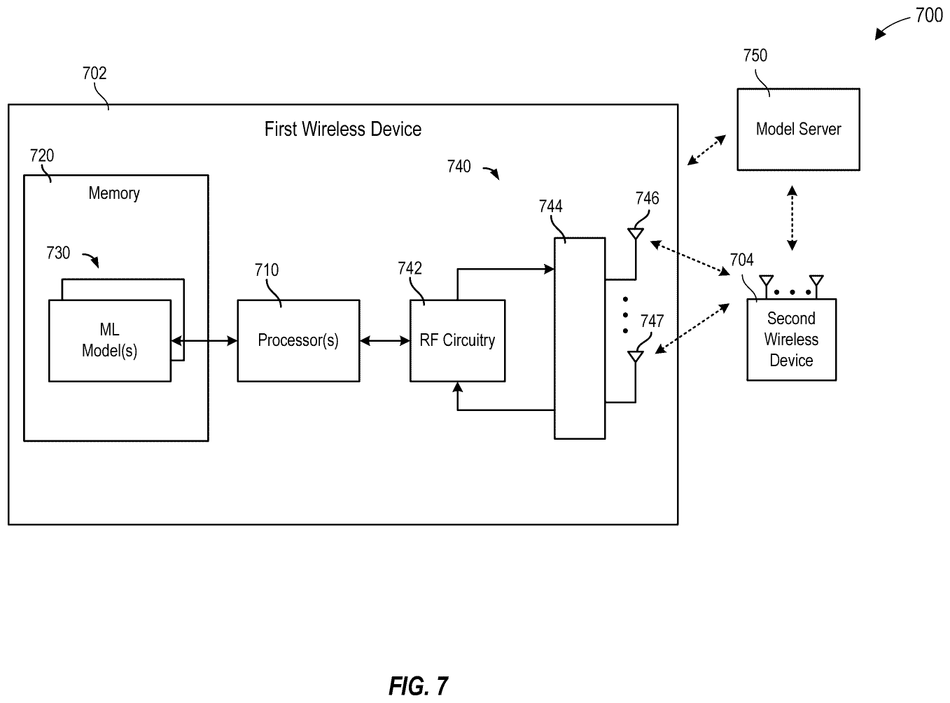

FIG. 7 illustrates an example AI architecture 700 of a first computing device 702 that is in communication with a second computing device 704. The first computing device 702 may be a server or cloud computing platform as described herein with respect to FIG. 6. Similarly, the second computing device 704 may be an embedded system or mobile device as described herein with respect to FIG. 6. Note that the AI architecture of the first computing device 702 may be applied to the second computing device 704.

The first computing device 702 may be, or may include, a chip, system on chip (SoC), a system in package (SiP), chipset, package or device that includes one or more processors, processing blocks or processing elements (collectively “the processor 710”) and one or more memory blocks or elements (collectively “the memory 720”).

As an example, in a model inference mode, the processor 710 may transform input data (e.g., images, sensor readings) from a specific domain into a format suitable for the domain-adaptive models. The processor 710 may then run the models on the formatted input data to generate an output estimate, utilizing the domain adaptation techniques described in this disclosure. The processor 710 may be coupled to a transceiver 740 for transmitting the output estimate to and/or receiving input data from one or more connected devices 746. The transceiver 740 includes interface circuitry 742 and 744 for converting between the digital signals of the processor and any transmission protocol used by the connected devices 746. The connected devices 746 may be sensors, actuators, displays, or storage that provide input to or consume the output from the models.

When receiving input data via the connected devices 746 (e.g., from the second computing device 704), the transceiver interface circuitry 742 and 744 may convert the received signals to a baseband frequency and then to digital signals for processing by the processor 710. The processor 710 may format the digital input signals and feed them into the domain-adaptive models for inference.

One or more ML models 730 may be stored in the memory 720 and accessible to the processor(s) 710. In certain cases, different ML models 730 with different characteristics may be stored in the memory 720, and a particular ML model 730 may be selected based on its characteristics and/or application as well as characteristics and/or conditions of first computing device 702 (e.g., a power state, a mobility state, a battery reserve, a temperature, etc.). For example, the ML models 730 may have different inference data and output pairings (e.g., different types of inference data produce different types of output), different levels of accuracies (e.g., 80%, 90%, or 95% accurate) associated with the predictions (e.g., the output 614 of FIG. 6), different latencies (e.g., processing times of less than 10 ms, 100 ms, or 1 second) associated with producing the predictions, different ML model sizes (e.g., file sizes), different coefficients or weights, etc.

The processor 710 may use the ML model 730 to produce output data (e.g., the output 614 of FIG. 6) based on input data (e.g., the inference data 612 of FIG. 6), for example, as described herein with respect to the inference host 604 of FIG. 6. The ML model 730 may be used to perform any of various AI-enhanced tasks, such as those listed above.

As an example, the ML model 730 may take input data from a specific domain to predict an estimate that is adapted to that domain using one or more example domain adaptation techniques previously described. The input data may include, for example, sensor measurements or observations from a particular domain, such as stereo image pairs, RGB-D frames, or consecutive video frames captured in indoor or outdoor environments. The output data may include, for example, an estimate of the desired quantity that is tailored to the input domain, such as a dense depth map or optical flow field, which is obtained by dynamically adjusting the model's hyperparameters based on the input data characteristics. In certain aspects, the output estimate may be considered a “virtual” result in that it is not directly measured but rather inferred by the model based on the input observations and the learned domain-specific representations. In other cases, the output estimate may correspond to a physical quantity that is measurable in principle but not directly observed by the sensors available to the system. Note that other input data and/or output data may be used in addition to or instead of the examples described herein, depending on the specific estimation task and the available sensors.

In certain aspects, a model server 750 may perform any of various ML model lifecycle management (LCM) tasks for the first computing device 702 and/or the second computing device 704. The model server 750 may operate as the model training host 602 and update the ML model 730 using training data from multiple domains to enable domain generalization. In some cases, the model server 750 may operate as the data source 606 to collect and host training data, inference data, and/or performance feedback associated with an ML model 730 across different domains. In certain aspects, the model server 750 may host various types and/or versions of the ML models 730 for the first computing device 702 and/or the second computing device 704 to download.

In some cases, the model server 750 may monitor and evaluate the performance of the ML model 730 that utilizes domain generalization and adaptation techniques to trigger one or more lifecycle management (LCM) tasks. For example, the model server 750 may determine whether to activate or deactivate the use of a particular domain-adaptive model at the first computing device 702 and/or the second computing device 704, based on factors such as the accuracy requirements, computational budget, and energy constraints of each device. The model server 750 may then provide instructions to the respective devices to manage their model usage accordingly. In some cases, the model server 750 may determine whether to switch to a different variant of the domain-generalized ML model 730 at the first computing device 702 and/or the second computing device 704, based on changes in the operating conditions or performance objectives. For instance, the model server may instruct a device to switch from a complex model with high accuracy to a simpler model with lower latency when the battery level falls below a threshold. In yet further examples, the model server 750 may act as a central coordinator for collaborative learning of domain-adaptive models across multiple devices, using techniques such as federated learning to train a global model from locally-computed updates while preserving data privacy.

### Example Artificial Intelligence Model

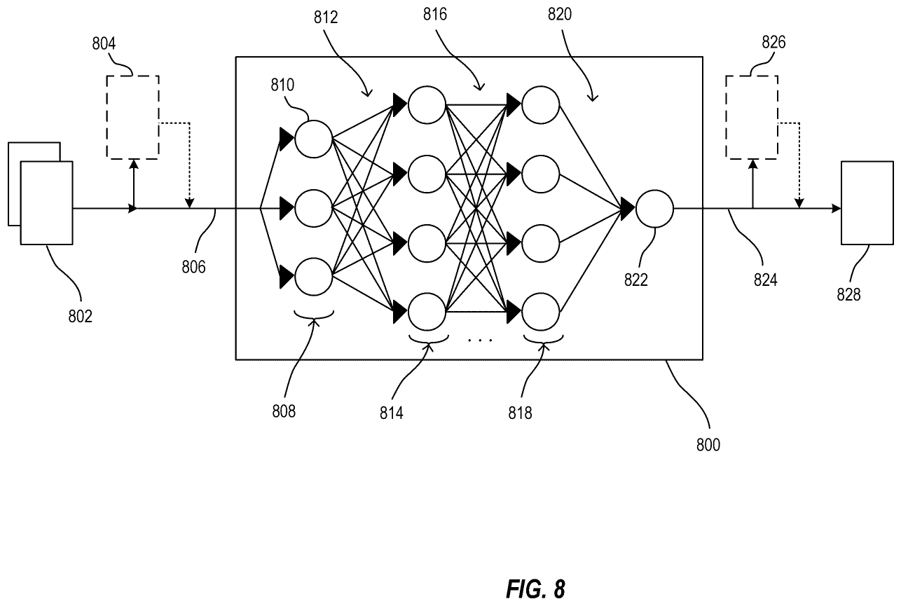

FIG. 8 is an illustrative block diagram of an example artificial neural network (ANN) 800 that can be used to implement the domain generalization and adaptation techniques described in this disclosure.

ANN 800 may receive input data 806 which may include one or more bits of data 802, pre-processed data output from pre-processor 804 (optional), or some combination thereof. Here, data 802 may include training data from multiple domains for domain generalization, inference data from a specific domain for domain adaptation, or the like, e.g., depending on the stage of development and/or deployment of ANN 800. Pre-processor 804 may be included within ANN 800 in some other implementations. Pre-processor 804 may, for example, process all or a portion of data 802 which may result in some of data 802 being changed, replaced, deleted, etc. In some implementations, pre-processor 804 may add additional data to data 802, such as domain-specific information or metadata.

ANN 800 includes at least one first layer 808 of artificial neurons 810 (e.g., perceptrons) to process input data 806 and provide resulting first layer output data via edges 812 to at least a portion of at least one second layer 814. Second layer 814 processes data received via edges 812 and provides second layer output data via edges 816 to at least a portion of at least one third layer 818. Third layer 818 processes data received via edges 816 and provides third layer output data via edges 820 to at least a portion of a final layer 822 including one or more neurons to provide output data 824. All or part of output data 824 may be further processed in some manner by (optional) post-processor 826. Thus, in certain examples, ANN 800 may provide output data 828 that is based on output data 824, post-processed data output from post-processor 826, or some combination thereof. Post-processor 826 may be included within ANN 800 in some other implementations. Post-processor 826 may, for example, process all or a portion of output data 824 which may result in output data 828 being different, at least in part, to output data 824, e.g., as result of data being changed, replaced, deleted, etc. In some implementations, post-processor 826 may be configured to add additional data to output data 824, such as domain-specific post-processing or adaptation. In this example, second layer 814 and third layer 818 represent intermediate or hidden layers that may be arranged in a hierarchical or other like structure. Although not explicitly shown, there may be one or more further intermediate layers between the second layer 814 and the third layer 818.

The structure and training of artificial neurons 810 in the various layers may be tailored to specific requirements of an application, such as domain generalization and adaptation for estimation tasks. Within a given layer of an ANN, some or all of the neurons may be configured to process information provided to the layer and output corresponding transformed information from the layer. For example, transformed information from a layer may represent a weighted sum of the input information associated with or otherwise based on a non-linear activation function or other activation function used to “activate” artificial neurons of a next layer. Artificial neurons in such a layer may be activated by or be responsive to weights and biases that may be adjusted during a training process to learn domain-invariant representations. Weights of the various artificial neurons may act as parameters to control a strength of connections between layers or artificial neurons, while biases may act as parameters to control a direction of connections between the layers or artificial neurons. An activation function may select or determine whether an artificial neuron transmits its output to the next layer or not in response to its received data. Different activation functions may be used to model different types of non-linear relationships. By introducing non-linearity into an ML model, an activation function allows the ML model to “learn” complex patterns and relationships in the input data (e.g., 612 in FIG. 6) across different domains. Some non-exhaustive example activation functions include a linear function, binary step function, sigmoid, hyperbolic tangent (tanh), a rectified linear unit (ReLU) and variants, exponential linear unit (ELU), Swish, Softmax, and others.

Design tools (such as computer applications, programs, etc.) may be used to select appropriate structures for ANN 800 and a number of layers and a number of artificial neurons in each layer, as well as selecting activation functions, a loss function, training processes, etc., to enable domain generalization and/or adaptation. Once an initial model has been designed, training of the model may be conducted using training data from multiple domains. Training data may include one or more datasets within which ANN 800 may detect, determine, identify or ascertain patterns that are consistent across domains. Training data may represent various types of information, including written, visual, audio, environmental context, operational properties, etc., from different domains. During training, parameters of artificial neurons 810 may be changed, such as to minimize or otherwise reduce a loss function or a cost function that measures the model's performance across domains. A training process may be repeated multiple times to fine-tune ANN 800 with each iteration to improve its domain generalization capability.

Various ANN model structures are available for consideration in the context of domain generalization and/or adaptation. For example, in a feedforward ANN structure each artificial neuron 810 in a layer receives information from the previous layer and likewise produces information for the next layer. In a convolutional ANN structure, some layers may be organized into filters that extract domain-invariant features from data (e.g., training data and/or input data). In a recurrent ANN structure, some layers may have connections that allow for processing of data across time, such as for processing information having a temporal structure, such as time series data forecasting across domains.

In an autoencoder ANN structure, compact representations of data may be processed and the model trained to predict or potentially reconstruct original data from a reduced set of features that capture domain-invariant patterns. An autoencoder ANN structure may be useful for tasks related to dimensionality reduction and data compression.

A generative adversarial ANN structure may include a generator ANN and a discriminator ANN that are trained to compete with each other. Generative-adversarial networks (GANs) are ANN structures that may be useful for tasks relating to generating synthetic data or improving the performance of other models in a domain-adaptive way. For example, a GAN could be used to generate realistic training data for a new domain to improve the domain generalization of another model.

A transformer ANN structure makes use of attention mechanisms that may enable the model to process input sequences in a parallel and efficient manner while capturing long-range dependencies and domain-specific patterns. An attention mechanism allows the model to focus on different parts of the input sequence at different times based on their relevance to the task and domain. Attention mechanisms may be implemented using a series of layers known as attention layers to compute, calculate, determine or select weighted sums of input features based on a similarity between different elements of the input sequence. A transformer ANN structure may include a series of feedforward ANN layers that may learn non-linear relationships between the input and output sequences in a domain-adaptive way. The output of a transformer ANN structure may be obtained by applying a linear transformation to the output of a final attention layer. A transformer ANN structure may be of particular use for tasks that involve sequence modeling, or other like processing, across different domains.

Another example type of ANN structure, is a model with one or more invertible layers. Models of this type may be inverted or “unwrapped” to reveal the input data that was used to generate the output of a layer, which can be useful for understanding how the model adapts to different domains.

Other example types of ANN model structures that can be used for domain generalization and/or adaptation include fully connected neural networks (FCNNs) and long short-term memory (LSTM) networks.

ANN 800 or other ML models may be implemented in various types of processing circuits along with memory and applicable instructions therein, for example, as described herein with respect to FIGS. 6 and 7. For example, general-purpose hardware circuits, such as, such as one or more central processing units (CPUs) and one or more graphics processing units (GPUs) may be employed to implement a model. One or more ML accelerators, such as tensor processing units (TPUs), embedded neural processing units (eNPUs), or other special-purpose processors, and/or field-programmable gate arrays (FPGAs), application-specific integrated circuits (ASICs), or the like also may be employed. Various programming tools are available for developing ANN models that can perform domain generalization and/or adaptation.

### Aspects of Artificial Intelligence Model Training

There are a variety of model training techniques and processes that may be used prior to, or at some point following, deployment of an ML model, such as ANN 800 of FIG. 8, to enable domain generalization and/or adaptation.

As part of the development process for machine learning models that utilize domain generalization and adaptation techniques, relevant training data must be gathered or generated from multiple domains. For example, training data may include ground truth labels for the desired output quantities (e.g., depth maps, flow fields, segmentation masks), as well as corresponding input observations (e.g., stereo pairs, video frames, images), from different domains such as indoor and outdoor scenes, daytime and nighttime conditions, or different sensor types. This data can be used to train the model to accurately estimate the desired quantities across a wide range of domains. In certain instances, the training data may originate from sensors on user devices (e.g., smartphones, robots, vehicles), dedicated data collection equipment (e.g., multi-camera rigs, depth sensors), or public datasets. In some cases, the training data may be aggregated from multiple sources to cover a wide range of scenarios and improve model generalization. For example, crowdsourcing platforms or online databases may be leveraged to gather diverse examples for training domain-adaptive models. In another example, training data may be generated synthetically using simulation engines or generative models to augment real-world samples and cover additional domains. The training data collection process can be performed offline, resulting in a static dataset for batch training, or online, where new samples are continuously incorporated into the model training pipeline. For example, an embedded system may periodically upload new training samples gathered during operation to a server, which then fine-tunes the domain-adaptive model using online learning techniques. For offline training, data collection and model updates can occur at a central location (e.g., a datacenter) or be distributed across multiple nodes (e.g., a sensor network). For online training, the model may be adapted locally on each device or by a remote server that receives streaming data from the devices.

In certain instances, all or part of the training data may be shared within a wireless communication system, or even shared (or obtained from) outside of the wireless communication system, to improve domain generalization.

Once an ML model has been trained with training data from multiple domains, its performance may be evaluated on held-out test data from both seen and unseen domains. In some scenarios, evaluation/verification tests may use a validation dataset, which may include data not in the training data, to compare the model's performance to baseline or other benchmark information across different domains. If model performance is deemed unsatisfactory, it may be beneficial to fine-tune the model, e.g., by changing its architecture, re-training it on the data with domain-specific adjustments, or using different optimization techniques that promote domain generalization, etc. Once a model's performance is deemed satisfactory across a wide range of domains, the model may be deployed accordingly. In certain instances, a model may be updated in some manner, e.g., all or part of the model may be changed or replaced, or undergo further training with data from new domains, just to name a few examples.

As part of a training process for an ANN, such as ANN 800 of FIG. 8, parameters affecting the functioning of the artificial neurons and layers may be adjusted to learn domain-invariant representations. For example, backpropagation techniques may be used to train the ANN by iteratively adjusting weights and/or biases of certain artificial neurons associated with errors between a predicted output of the model and a desired output that may be known or otherwise deemed acceptable across different domains. Backpropagation may include a forward pass, a loss function, a backward pass, and a parameter update that may be performed in training iteration. The process may be repeated for a certain number of iterations for each set of training data until the weights of the artificial neurons/layers are adequately tuned to minimize domain-specific biases.

Backpropagation techniques associated with a loss function may measure how well a model is able to predict a desired output for a given input across different domains. An optimization algorithm may be used during a training process to adjust weights and/or biases to reduce or minimize the loss function which should improve the performance of the model on unseen domains. There are a variety of optimization algorithms that may be used along with backpropagation techniques or other training techniques to promote domain generalization. Some initial examples include a gradient descent based optimization algorithm and a stochastic gradient descent based optimization algorithm. A stochastic gradient descent (or ascent) technique may be used to adjust weights/biases in order to minimize or otherwise reduce a loss function that measures cross-domain performance. A mini-batch gradient descent technique, which is a variant of gradient descent, may involve updating weights/biases using a small batch of training data from different domains rather than the entire dataset. A momentum technique may accelerate an optimization process by adding a momentum term to update or otherwise affect certain weights/biases in a domain-agnostic way.

An adaptive learning rate technique may adjust a learning rate of an optimization algorithm associated with one or more characteristics of the training data from different domains. A batch normalization technique may be used to normalize inputs to a model in order to stabilize a training process and potentially improve the performance of the model across domains.

A “dropout” technique may be used to randomly drop out some of the artificial neurons from a model during a training process, e.g., in order to reduce overfitting to specific domains and potentially improve the generalization of the model to unseen domains.

An “early stopping” technique may be used to stop an on-going training process early, such as when a performance of the model using a validation dataset from a different domain starts to degrade.

Another example technique includes data augmentation to generate additional training data by applying domain-specific transformations to all or part of the training information.

A transfer learning technique may be used which involves using a pre-trained model as a starting point for training a new model on a different domain, which may be useful when training data from the new domain is limited or when there are multiple tasks that are related to each other across domains.

A multi-task learning technique may be used which involves training a model to perform multiple tasks simultaneously across different domains to potentially improve the performance of the model on one or more of the tasks in a domain-agnostic way. Hyperparameters or the like may be input and applied during a training process in certain instances to control the degree of domain generalization.

Another example technique that may be useful with regard to an ML model for domain generalization is some form of a “pruning” technique. A pruning technique, which may be performed during a training process or after a model has been trained, involves the removal of unnecessary (e.g., because they have no impact on the output) or less necessary (e.g., because they have negligible impact on the output), or possibly redundant features from a model. In certain instances, a pruning technique may reduce the complexity of a model or improve efficiency of a model without undermining the intended performance of the model across different domains.

Pruning techniques may be particularly useful in the context of wireless communication, where the available resources (such as power and bandwidth) may be limited. Some example pruning techniques include a weight pruning technique, a neuron pruning technique, a layer pruning technique, a structural pruning technique, and a dynamic pruning technique. Pruning techniques may, for example, reduce the amount of data corresponding to a model that may need to be transmitted or stored, while preserving its domain generalization capability.

Weight pruning techniques may involve removing some of the weights from a model. Neuron pruning techniques may involve removing some neurons from a model. Layer pruning techniques may involve removing some layers from a model. Structural pruning techniques may involve removing some connections between neurons in a model. Dynamic pruning techniques may involve adapting a pruning strategy of a model associated with one or more characteristics of the data or the environment. For example, in certain wireless communication devices, a dynamic pruning technique may more aggressively prune a model for use in a low-power or low-bandwidth environment, and less aggressively prune the model for use in a high-power or high-bandwidth environment. In certain aspects, pruning techniques also may be applied to training data, e.g., to remove outliers, etc. In some implementations, pre-processing techniques directed to all or part of a training dataset may improve model performance or promote faster convergence of a model. For example, training data may be pre-processed to change or remove unnecessary data, extraneous data, incorrect data, or otherwise identifiable data. Such pre-processed training data may, for example, lead to a reduction in potential overfitting, or otherwise improve the performance of the trained model.

One or more of the example training techniques presented above may be employed as part of a training process. As above, some example training processes that may be used to train an ML model include supervised learning, unsupervised learning, semi-supervised learning, and reinforcement learning technique.

Decentralized, distributed, or shared learning, such as federated learning, may enable training of machine learning models that utilize domain adaptation and/or generalization techniques on data distributed across multiple devices or organizations, without the need to centralize the data or the training process. Federated learning is particularly useful when the training data is sensitive or subject to privacy constraints, or when it is impractical, inefficient, or expensive to gather all the data in one place. In the context of estimation tasks such as depth prediction or flow computation, for example, federated learning may be used to improve model performance by allowing it to learn from a wide range of environments and conditions. For instance, a depth estimation model may be trained on data collected from a large number of smartphones or autonomous vehicles, each with its own camera configuration and operating domain, to improve its robustness and generalization. With federated learning, each device may receive a copy of the model and perform local training using its own data to capture device-specific patterns. The devices then send only the updated model parameters (e.g., weights and biases) to a central server, without revealing the raw data. The server aggregates the contributions from all devices and updates the global model, which is then redistributed to the devices for the next round of local training. This process is repeated iteratively until the depth estimation model achieves satisfactory performance across all participating devices. By enabling collaborative learning while keeping data localized, federated learning allows the development of models that can leverage diverse datasets without compromising privacy or security.

In some implementations, one or more devices or services may support processes relating to the usage, maintenance, activation, and reporting of machine learning models that utilize domain generalization and/or adaptation techniques. In certain instances, all or part of the training data or the trained model may be shared across multiple devices to provide or improve the estimation capabilities. For example, a smartphone with a depth sensor may share its data with a smartphone having only a single camera, enabling the latter to train a depth estimation model using domain generalization and/or adaptation techniques. In some cases, signaling mechanisms may be employed to communicate the capabilities and requirements for performing specific functions related to domain generalization and/or adaptation techniques, such as the supported input and output formats, the available computational resources, or the ability to collect and share training data. These models may be used to support various applications, such as augmented reality, robotics, autonomous driving, or video processing, where accurate and efficient estimation of quantities like depth, flow, or segmentation is crucial.

### Example Method for Domain Generalization and Adaptation in Machine Learning Models

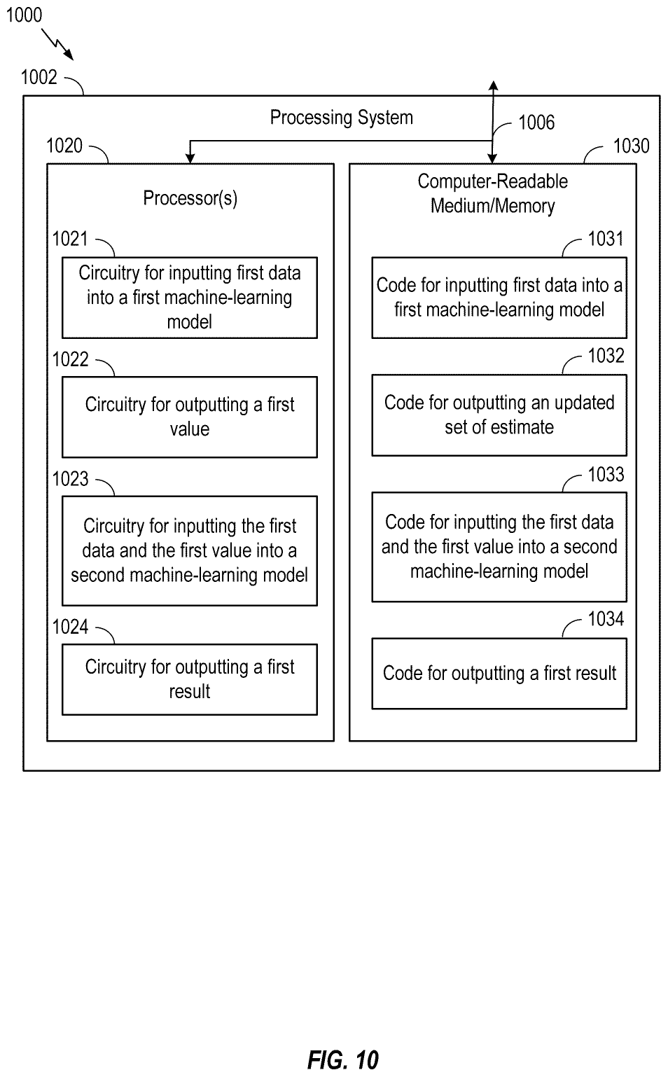

In one aspect, method 900, or any aspect related to it, may be performed by an apparatus, such as processing system 1000 of FIG. 10, which includes various components operable, configured, or adapted to perform the method 900.

Method 900 begins at 902 with inputting the first input data into a first machine learning model.

Method 900 may then proceed to 904 with outputting, by the first machine learning model, a first value for a hyperparameter of a second machine learning model.

Method 900 may then proceed to 906 with inputting the first input data and the first value for the hyperparameter into the second machine learning model.

Method 900 may then end at 908 with outputting, by the second machine learning model, a first result based on the first input data and the first value for the hyperparameter.

In some aspects, method 900 may further comprise: inputting second input data into the first machine learning model; outputting, by the first machine learning model, a second value for the hyperparameter; inputting the second input data and the second value for the hyperparameter into the second machine learning model; and outputting, by the second machine learning model, a second result based on the second input data and the second value for the hyperparameter.

In some aspects of method 900, the hyperparameter is encoded within a latent feature space.

In some aspects of method 900, the hyperparameter is a non-learnable parameter of the second machine learning model.

In some aspects, method 900 may further comprise training the second machine learning model on one or more datasets corresponding to one or more domains excluding a first domain, wherein the first input data is in the first domain.

In some aspects of method 900, the first value for the hyperparameter corresponds to a range of values.

In some aspects of method 900, the first value represents at least one of a disparity value, depth value, or motion value.

In some aspects, method 900 may further comprise training the second machine learning model, configured with a set of values for a set of hyperparameters excluding the hyperparameter, on one or more datasets.

In some aspects, method 900 may further comprise training the first machine learning model on the one or more datasets.

In some aspects of method 900, training the second machine learning model comprises minimizing the loss function that also compares second output of the second machine learning model to the ground truth.

In some aspects of method 900, the second machine learning model is configured to use a set of hyperparameters including the hyperparameter, wherein at least a second hyperparameter of the set of hyperparameters has a fixed value.

In some aspects of method 900, the first input data comprises image data, and wherein the hyperparameter is related to a characteristic of the image data.

In some aspects of method 900, the characteristic of the image data is at least one of a resolution, a contrast, a brightness, or a noise level.

In some aspects of method 900, the second machine learning model is configured to perform a task including at least one of stereo depth estimation, optical flow estimation, object detection, object classification, or semantic segmentation.

In some aspects, method 900 may further comprises receiving the first input data via at least one modem and one or more antennas.

In some aspects of method 900, the one or more antennas are integrated into one of a vehicle, an extra-reality device, or a mobile device.

In some aspects, method 900 further comprises receiving the first input data from at least one image sensor, wherein the first input data comprises one or more images.

In some aspects, the second machine learning model is configured to perform a depth estimation task, and the first value for the hyperparameter comprises a maximum disparity range for the depth estimation task.

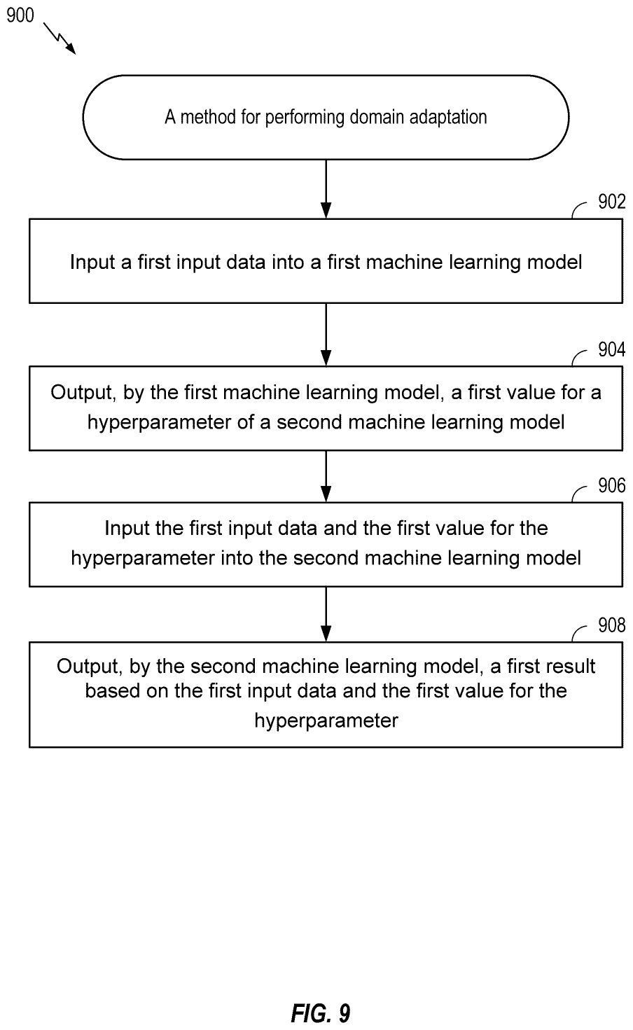

Note that FIG. 9 is just one example of a method, and other methods including fewer, additional, or alternative steps are possible consistent with this disclosure.

### Example Processing System for Domain Generalization and Adaptation in Machine Learning Models

FIG. 10 depicts aspects of an example processing system 1000.

The processing system 1000 includes a processing system 1002 includes one or more processors 1020. The one or more processors 1020 are coupled to a computer-readable medium/memory 1030 via a bus 1006. In certain aspects, the computer-readable medium/memory 1030 is configured to store instructions (e.g., computer-executable code) that when executed by the one or more processors 1020, cause the one or more processors 1020 to perform the method 900 described with respect to FIG. 9, or any aspect related to it, including any additional steps or sub-steps described in relation to FIG. 9.

In the depicted example, computer-readable medium/memory 1030 stores code (e.g., executable instructions) for inputting first data into a first machine-learning model 1031, code for outputting a first value 1032, code for inputting the first data and the first value into a second machine-learning model 1033, and code for outputting a first result 1034. Processing of the code 1031-1034 may enable and cause the processing system 1000 to perform the method 900 described with respect to FIG. 9, or any aspect related to it.

The one or more processors 1020 include circuitry configured to implement (e.g., execute) the code stored in the computer-readable medium/memory 1030, including circuitry for inputting first data into a first machine-learning model 1021, circuitry for outputting a first value 1022, circuitry for inputting the first data and the first value into a second machine-learning model 1023, and circuitry for outputting a first result 1024 Processing with circuitry 1021-1024 may enable and cause the processing system 1000 to perform the method 900 described with respect to FIG. 9, or any aspect related to it.

### Example Clauses

Implementation examples are described in the following numbered clauses:

Clause 1: A method for performing domain generalization and/or domain adaptation, comprising: inputting first input data into a first machine learning model; outputting, by the first machine learning model, a first value for a hyperparameter of a second machine learning model; inputting the first input data and the first value for the hyperparameter into the second machine learning model; and outputting, by the second machine learning model, a first result based on the first input data and the first value for the hyperparameter.

Clause 2: A method in accordance with Clause 1, further comprising: inputting second input data into the first machine learning model; outputting, by the first machine learning model, a second value for the hyperparameter; inputting the second input data and the second value for the hyperparameter into the second machine learning model; and outputting, by the second machine learning model, a second result based on the second input data and the second value for the hyperparameter.

Clause 3: A method in accordance with any one of Clauses 1 or 2, wherein the hyperparameter is encoded within a latent feature space.

Clause 4: A method in accordance with any one of Clauses 1-3, wherein the hyperparameter is a non-learnable parameter of the second machine learning model.

Clause 5: A method in accordance with any one of Clauses 1-4, further comprising: training the second machine learning model on one or more datasets corresponding to one or more domains excluding a first domain, wherein the first input data is in the first domain.

Clause 6: A method in accordance with any one of Clauses 1-5, wherein the first value for the hyperparameter corresponds to a range of values.

Clause 7: A method in accordance with any one of Clauses 1-6, wherein the first value represents at least one of a disparity value, depth value, or motion value.

Clause 8: A method in accordance with any one of Clauses 1-7, further comprising: training the second machine learning model, configured with a set of values for a set of hyperparameters excluding the hyperparameter, on one or more datasets.

Clause 9: A method in accordance with any one of Clauses 1-8, further comprising training the first machine learning model on the one or more datasets.

Clause 10: A method in accordance with Clause 9, wherein training the first machine learning model comprises minimizing a loss function that compares first output of the first machine learning model to a ground truth.

Clause 11: A method in accordance with Clause 10, wherein to train the second machine learning model comprises to minimize the loss function that also compares second output of the second machine learning model to the ground truth.

Clause 12: A method in accordance with any one of Clauses 1-11, wherein the second machine learning model is configured to use a set of hyperparameters including the hyperparameter, wherein at least a second hyperparameter of the set of hyperparameters has a fixed value.

Clause 13: A method in accordance with any one of Clauses 1-12, wherein the first input data comprises image data, and wherein the hyperparameter is related to a characteristic of the image data.

Clause 14: A method in accordance with Clause 13, wherein the characteristic of the image data is at least one of a resolution, a contrast, a brightness, or a noise level.

Clause 15: A method in accordance with any one of Clauses 1-14, wherein the second machine learning model is configured to perform a task including at least one of stereo depth estimation, optical flow estimation, object detection, object classification, or semantic segmentation.

Clause 16: A method in accordance with any one of Clauses 1-15, wherein a modem and one or more antennas are configured to receive the first input data.

Clause 17: A method in accordance with Clause 16, wherein the modem and the one or more antennas are integrated into one of a vehicle, an extra-reality device, or a mobile device.

Clause 18: A method in accordance with any one of Clauses 1-17, further comprising receiving the first input data from at least one image sensor, wherein the first input data comprises one or more images.

Clause 19: A method in accordance with any one of Clauses 1-18, wherein the second machine learning model is configured to perform a depth estimation task, and wherein the first value for the hyperparameter comprises a maximum disparity range for the depth estimation task.

Clause 20: One or more apparatuses, comprising: one or more memories comprising executable instructions; and one or more processors configured to execute the executable instructions and cause the one or more apparatuses to perform a method in accordance with any one of clauses 1-19.

Clause 21: One or more apparatuses, comprising: one or more memories; and one or more processors, coupled to the one or more memories, configured to cause the one or more apparatuses to perform a method in accordance with any one of Clauses 1-19.

Clause 22: One or more apparatuses, comprising: one or more memories; and one or more processors, coupled to the one or more memories, configured to perform a method in accordance with any one of Clauses 1-19.

Clause 23: One or more apparatuses, comprising means for performing a method in accordance with any one of Clauses 1-19.

Clause 24: One or more non-transitory computer-readable media comprising executable instructions that, when executed by one or more processors of one or more apparatuses, cause the one or more apparatuses to perform a method in accordance with any one of Clauses 1-19.

Clause 25: One or more computer program products embodied on one or more computer-readable storage media comprising code for performing a method in accordance with any one of Clauses 1-19.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, an AI processor, a digital signal processor (DSP), an ASIC, a field programmable gate array (FPGA) or other programmable logic device (PLD), discrete gate or transistor logic, discrete hardware components, or any combination thereof designed to perform the functions described herein. A general purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, “coupled to” and “coupled with” generally encompass direct coupling and indirect coupling (e.g., including intermediary coupled aspects) unless stated otherwise. For example, stating that a processor is coupled to a memory allows for a direct coupling or a coupling via an intermediary aspect, such as a bus.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Reference to an element in the singular is not intended to mean only one unless specifically so stated, but rather “one or more.” The subsequent use of a definite article (e.g., “the” or “said”) with an element (e.g., “the processor”) is not intended to invoke a singular meaning (e.g., “only one”) on the element unless otherwise specifically stated. For example, reference to an element (e.g., “a processor,” “a controller,” “a memory,” “a transceiver,” “an antenna,” “the processor,” “the controller,” “the memory,” “the transceiver,” “the antenna,” etc.), unless otherwise specifically stated, should be understood to refer to one or more elements (e.g., “one or more processors,” “one or more controllers,” “one or more memories,” “one more transceivers,” etc.). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more. All structural and functional equivalents to the elements of the various aspects described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims.

What is claimed is:

1. An apparatus configured to perform domain adaptation, comprising:
one or more memories configured to store first input data; and
one or more processors, coupled to the one or more memories, configured to:
input the first input data into a first machine learning model;
output, by the first machine learning model, a first value for a hyperparameter of a second machine learning model;
input the first input data and the first value for the hyperparameter into the second machine learning model; and
output, by the second machine learning model, a first result based on the first input data and the first value for the hyperparameter.

2. The apparatus of claim 1, wherein the one or more processors are further configured to:
input second input data into the first machine learning model;
output, by the first machine learning model, a second value for the hyperparameter;
input the second input data and the second value for the hyperparameter into the second machine learning model; and
output, by the second machine learning model, a second result based on the second input data and the second value for the hyperparameter.

3. The apparatus of claim 1, wherein the hyperparameter is encoded within a latent feature space.

4. The apparatus of claim 1, wherein the hyperparameter is a non-learnable parameter of the second machine learning model.

5. The apparatus of claim 1, wherein the one or more processors are further configured to:
train the second machine learning model on one or more datasets corresponding to one or more domains excluding a first domain, wherein the first input data is in the first domain.

6. The apparatus of claim 1, wherein the first value for the hyperparameter corresponds to a range of values.

7. The apparatus of claim 1, wherein the first value represents at least one of a disparity value, depth value, or motion value.

8. The apparatus of claim 1, wherein the one or more processors are further configured to:
train the second machine learning model, configured with a set of values for a set of hyperparameters excluding the hyperparameter, on one or more datasets.

9. The apparatus of claim 8, wherein the one or more processors are configured to train the first machine learning model on the one or more datasets.

10. The apparatus of claim 9, wherein to train the first machine learning model comprises to minimize a loss function that compares first output of the first machine learning model to a ground truth.

11. The apparatus of claim 10, wherein to train the second machine learning model comprises to minimize the loss function that compares second output of the second machine learning model to the ground truth.

12. The apparatus of claim 1, wherein the second machine learning model is configured to use a set of hyperparameters including the hyperparameter, wherein at least a second hyperparameter of the set of hyperparameters has a fixed value.

13. The apparatus of claim 1, wherein the first input data comprises image data, and wherein the hyperparameter is related to a characteristic of the image data.

14. The apparatus of claim 13, wherein the characteristic of the image data is at least one of a resolution, a contrast, a brightness, or a noise level.

15. The apparatus of claim 1, wherein the second machine learning model is configured to perform a task including at least one of stereo depth estimation, optical flow estimation, object detection, object classification, or semantic segmentation.

16. The apparatus of claim 1, further comprising a modem, coupled to one or more antennas, and coupled to one or more processors, wherein the modem and the one or more antennas are configured to receive the first input data.

17. The apparatus of claim 16, wherein the modem and the one or more antennas are integrated into one of a vehicle, an extra-reality device, or a mobile device.

18. The apparatus of claim 1, further comprising at least one image sensor configured to acquire the first input data, wherein the first input data comprises one or more images.

19. The apparatus of claim 1, wherein the second machine learning model is configured to perform a depth estimation task, and wherein the first value for the hyperparameter comprises a maximum disparity range for the depth estimation task.

20. A method for performing domain generalization, comprising:
inputting first input data into a first machine learning model;
outputting, by the first machine learning model, a first value for a hyperparameter of a second machine learning model;
inputting the first input data and the first value for the hyperparameter into the second machine learning model; and
outputting, by the second machine learning model, a first result based on the first input data and the first value for the hyperparameter.
